(19) United States
(12) Patent Application Publication
(10) Pub. No.: US 2025/0069819 A1
(43) Pub. Date: Feb. 27, 2025

(54) ELECTROLYTIC CAPACITOR

(71) Applicant: Panasonic Intellectual Property Management Co., Ltd., Osaka (JP)

(72) Inventors: YUTA MATSUKI, Osaka (JP); YOUHEI ASHIMORI, Fukui (JP); TATSUJI AOYAMA, Kyoto (JP); SHINTARO WAKIYAMA, Yamaguchi (JP)

(21) Appl. No.: 18/726,790

(22) PCT Filed: Jan. 5, 2023
(86) PCT No.: PCT/JP2023/000040

§ 371 Date: Jul. 3, 2024

(30) Foreign Application Priority Data
Jan. 19, 2022 (JP) 2022-006644
Jan. 19, 2022 (JP) 2022-006645

(51) Int. Cl. H01G 9/10; H01G 9/00; H01G 9/012; H01G 9/15

(52) U.S. Cl. CPC H01G 9/10; H01G 9/0003; H01G 9/012; H01G 9/151

(57) ABSTRACT

An electrolytic capacitor includes a winding portion, an anode lead member, and a cathode lead member. The winding portion includes an anode foil and a cathode foil that are wound. The anode lead member is connected to the anode foil and extends in a first direction. The cathode lead member is connected to the cathode foil and extends in the first direction. The winding portion has a shape viewed in the first direction, the shape including a first peripheral region and a second peripheral region that are opposed to each other in a second direction intersecting the first direction, and a third peripheral region and a fourth peripheral region that are opposed to each other in a third direction intersecting the first direction and the second direction. The length of the winding portion in the third direction is larger than the length of the winding portion in the second direction. The anode lead member and the cathode lead member are arranged point-symmetrically with respect to a center of the winding portion when viewed in the first direction.

### TECHNICAL FIELD

The present disclosure relates generally to electrolytic capacitors. More specifically, the present disclosure relates to an electrolytic capacitor having a winding portion in which an anode foil and a cathode foil are wound.

### BACKGROUND

PTL 1 discloses a method of manufacturing a flat-type electrolytic capacitor. In the method of manufacturing a flat-type electrolytic capacitor in which a capacitor element having an anode foil and a cathode foil that are wound via a separator is housed in a closed-end tubular flat-type outer case, and an open end of the outer case is sealed by a sealing member; the wound capacitor element is formed in a flat shape and impregnated with an electrolyte after being housed in the outer case.

PTL 2 discloses a winding capacitor, including a capacitor element comprising a winding material sandwiched by a pair of winding shafts to be wound and made into a winding core. In this winding capacitor, a pair of heat radiating members with a shape identical to a shape of a pair of drawn-out winding shafts in the capacitor element are inserted into the winding core.

### CITATION LIST

### Patent Literature

PTL 1: Unexamined Japanese Patent Publication No. 2003-297673
PTL 2: Unexamined Japanese Patent Publication No. 2010-199502

### SUMMARY

An electrolytic capacitor according to a first aspect of the present disclosure includes a winding portion, an anode lead member, and a cathode lead member. The winding portion includes an anode foil and a cathode foil that are wound. The anode lead member is connected to the anode foil and extends in a first direction. The cathode lead member is connected to the cathode foil and extends in the first direction. The winding portion has a shape viewed in the first direction, the shape including a first peripheral region and a second peripheral region that are opposed to each other in a second direction intersecting the first direction, and a third peripheral region and a fourth peripheral region that are opposed to each other in a third direction intersecting the first direction and the second direction. A length of the winding portion in the third direction is larger than a length of the winding portion in the second direction. The anode lead member and the cathode lead member are arranged point-symmetrically with respect to a center of the winding portion when viewed in the first direction.

An electrolytic capacitor according to a second aspect of the present disclosure includes a winding portion, a first anode lead member and a second anode lead member, and a first cathode lead member and a second cathode lead member. The winding portion includes an anode foil and a cathode foil that are wound. The first anode lead member and the second anode lead member are connected to the anode foil and each extend in a first direction. The first cathode lead member and the second cathode lead member are connected to the cathode foil and each extend in the first direction. The winding portion has a shape viewed in the first direction, the shape including a first peripheral region and a second peripheral region that are opposed to each other in a second direction intersecting the first direction, and a third peripheral region and a fourth peripheral region that are opposed to each other in a third direction intersecting the first direction and the second direction. A length of the winding portion in the third direction is larger than a length of the winding portion in the second direction. The first anode lead member is located at a first end of the first peripheral region when viewed in the first direction. The first cathode lead member is located at a second end of the first peripheral region when viewed in the first direction. The second anode lead member is located at a third end of the second peripheral region when viewed in the first direction, the third end being opposed to the first end. The second cathode lead member is located at a fourth end of the second peripheral region when viewed in the first direction, the third end being opposed to the second end.

An electrolytic capacitor according to a third aspect of the present disclosure includes a capacitor element, a container, and a heat dissipation member. The capacitor element includes a winding portion in which an anode foil and a cathode foil are wound. The container houses the capacitor element. The heat dissipation member dissipates heat generated inside the container. The heat dissipation member includes a plate portion having a plate shape and a column portion extending from one surface of the plate portion. The column portion is inserted into the winding portion. The plate portion is in contact with the container.

### Advantageous Effects of Invention

According to the electrolytic capacitors of the first and second aspects of the present disclosure, the vibration resistance of the electrolytic capacitor can be improved. According to the electrolytic capacitor of the third aspect of the present disclosure, heat generated in the electrolytic capacitor can be dissipated more efficiently.

### BRIEF DESCRIPTION OF THE DRAWINGS

FIG. 1 is a see-through perspective view illustrating an electrolytic capacitor according to a first exemplary embodiment.

FIG. 2 is a partially developed perspective view illustrating a capacitor element of the electrolytic capacitor of the first exemplary embodiment.

FIG. 3 is a front view illustrating the electrolytic capacitor of the first exemplary embodiment.

FIG. 4 is a sectional view taken along line Z1-Z1 of FIG. 3.

FIG. 5 is a plan view illustrating the electrolytic capacitor of the first exemplary embodiment.

FIG. 6 is a sectional view taken along line X1-X1 of FIG. 5.

FIG. 7 is a sectional view taken along line X2-X2 of FIG. 5.

FIG. 8 is an external perspective view illustrating the electrolytic capacitor of the first exemplary embodiment as viewed from above.

FIG. 9 is an exploded perspective view illustrating the electrolytic capacitor of the first exemplary embodiment as viewed from above.

FIG. 10 is an exploded perspective view illustrating the electrolytic capacitor of the first exemplary embodiment as viewed from below.

FIG. 11 is an external perspective view illustrating the electrolytic capacitor of the first exemplary embodiment as viewed from below.

FIG. 12 is an external perspective view illustrating an electrolytic capacitor according to a first modification of the first exemplary embodiment as viewed from below.

FIG. 13 is an external perspective view illustrating an electrolytic capacitor according to a further modification of the first modification of the first exemplary embodiment as viewed from below.

FIG. 14 is an external perspective view illustrating an electrolytic capacitor according to a further modification of the first modification that is different from FIG. 13 as viewed from below.

FIG. 15 is a plan sectional view illustrating an electrolytic capacitor according to a second modification of the first exemplary embodiment.

FIG. 16 is a plan sectional view illustrating an electrolytic capacitor according to a third modification of the first exemplary embodiment.

FIG. 17 is a partially developed perspective view illustrating a capacitor element of an electrolytic capacitor according to a second exemplary embodiment.

FIG. 18 is a see-through perspective view illustrating the electrolytic capacitor of the second exemplary embodiment.

FIG. 19 is a plan sectional view illustrating the electrolytic capacitor of the second exemplary embodiment.

FIG. 20 is a sectional view illustrating an electrolytic capacitor in a third exemplary embodiment.

FIG. 21 is an external perspective view illustrating the electrolytic capacitor of the third exemplary embodiment.

FIG. 22 is a perspective view illustrating the electrolytic capacitor of the third exemplary embodiment as viewed from below.

FIG. 23 is an exploded perspective view illustrating the electrolytic capacitor of the third exemplary embodiment.

FIG. 24 is an exploded perspective view illustrating the electrolytic capacitor of the third exemplary embodiment as viewed from below.

FIG. 25 is a perspective view illustrating an electrolytic capacitor according to a first modification of the third exemplary embodiment as viewed from below.

FIG. 26 is a perspective view illustrating an electrolytic capacitor according to the first modification of the third exemplary embodiment that is different from FIG. 25 as viewed from below.

### DESCRIPTION OF EMBODIMENT

When the flat-type electrolytic capacitor as described in PTL 1 is mounted on a substrate via a plurality of lead wires connected to an anode foil and a cathode foil, respectively, a load of the flat-type electrolytic capacitor applied to the plurality of lead wires is biased, and vibration resistance may be deteriorated.

The first and second aspects of the present disclosure each provide an electrolytic capacitor capable of improving vibration resistance.

An electrolytic capacitor such as the winding capacitor of PTL 2 is required to efficiently dissipate heat generated therein.

The third aspect of the present disclosure provides an electrolytic capacitor capable of efficiently dissipating heat generated therein.

Hereinafter, an electrolytic capacitor according to an exemplary embodiment of the present disclosure will be described in detail with reference to the drawings. Note that exemplary embodiments and modifications to be described below are merely examples of the present disclosure, and the present disclosure is not limited to the exemplary embodiments and the modifications. Even in a case other than the exemplary embodiments and the modifications, various changes can be made in accordance with the design and the like without departing from the technical idea of the present disclosure. The following exemplary embodiments (including modifications) may be implemented by being appropriately combined.

### (1) First Exemplary Embodiment

### (1-1) Outline

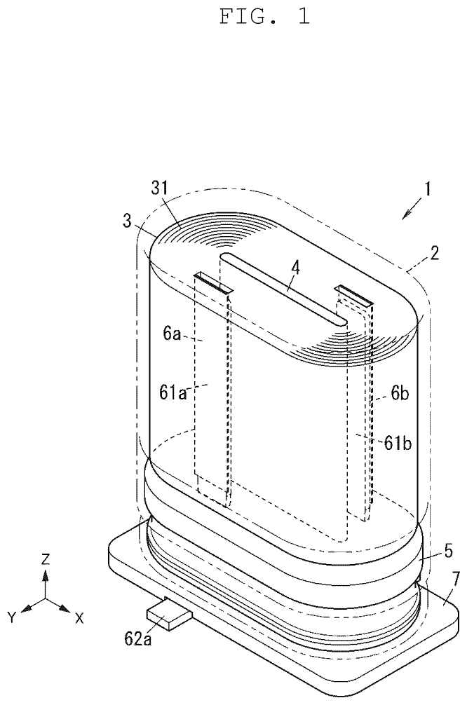

Hereinafter, an outline of electrolytic capacitor 1 will be described with reference to FIGS. 1 to 4. Each drawing described in the following exemplary embodiments is a schematic view, and the ratio of the size and the thickness of each component in each drawing does not necessarily reflect the actual dimensional ratio.

As illustrated in FIGS. 1 to 3, electrolytic capacitor 1 includes winding portion 31, anode lead member 6a, and cathode lead member 6b.

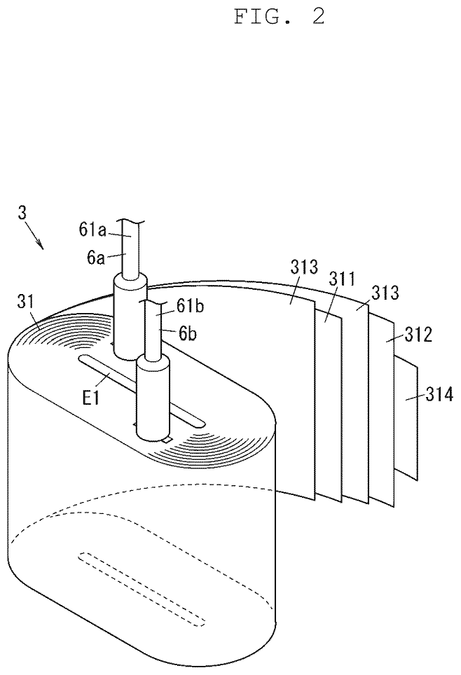

As illustrated in FIG. 2, winding portion 31 includes anode foil 311 and cathode foil 312 that are wound.

Anode lead member 6a is connected to anode foil 311 and extends in a first direction (Z-axis direction in FIG. 1). Cathode lead member 6b is connected to cathode foil 312 and extends in the first direction.

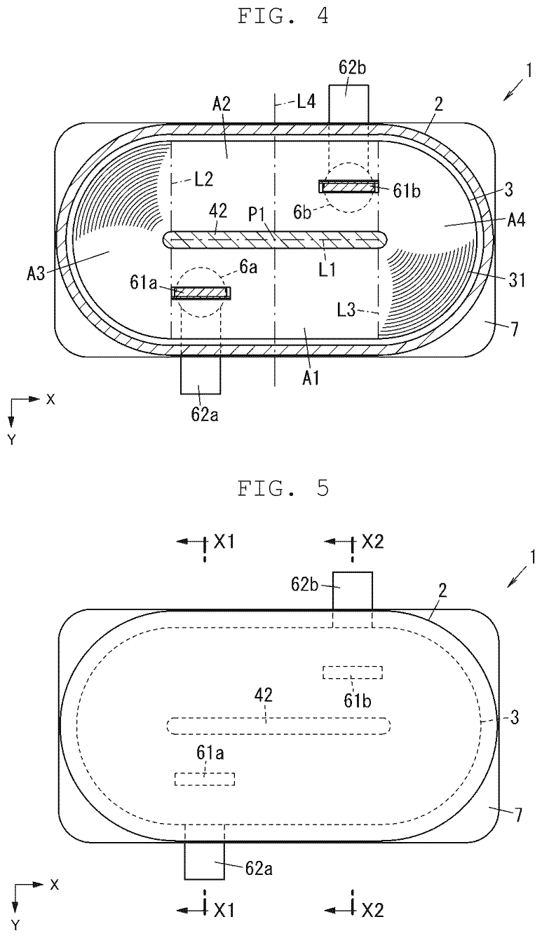

As illustrated in FIG. 4, winding portion 31 includes first peripheral region A1 and second peripheral region A2 whose shapes viewed in the first direction are opposed to each other in a second direction (Y-axis direction) intersecting the first direction, and third peripheral region A3 and fourth peripheral region A4 whose shapes viewed in the first direction are opposed to each other in a third direction (X-axis direction) intersecting the first direction and the second direction.

The length of winding portion 31 in the third direction is larger than the length of winding portion 31 in the second direction.

Anode lead member 6a and cathode lead member 6b are arranged point-symmetrically with respect to center P1 of winding portion 31 when viewed in the first direction.

Here, first peripheral region A1 to fourth peripheral region A4 are regions in winding portion 31 divided by reference lines L1 to L3, which are imaginary lines. In the drawings, dash-dot lines representing reference lines L1 to L3 are not substantial. Being arranged “point-symmetrically” is not limited to being arranged at strictly point-symmetric positions, and includes a state of being arranged at positions slightly shifted from point-symmetric positions.

According to the above configuration, anode lead member 6a and cathode lead member 6b are arranged point-symmetrically with respect to center P1, and thus an insulation distance between anode lead member 6a and cathode lead member 6b can be secured. When electrolytic capacitor 1 is mounted on a substrate such that anode lead member 6a and cathode lead member 6b are joined to the substrate with a joining material such as solder, the load of electrolytic capacitor 1 is uniformly applied to anode lead member 6a and cathode lead member 6b. This can improve stability of electrolytic capacitor 1. Thus, even when electrolytic capacitor 1 is applied with vibration, stability (vibration resistance) against vibration of electrolytic capacitor 1 can be secured. Anode lead member 6a and cathode lead member 6b can be disposed in a well-balanced manner, and thus the center of gravity of the electrolytic capacitor gets close to center P1, enabling stability (vibration resistance) against vibration of electrolytic capacitor 1 to be secured.

### (1-2) Detailed Configuration

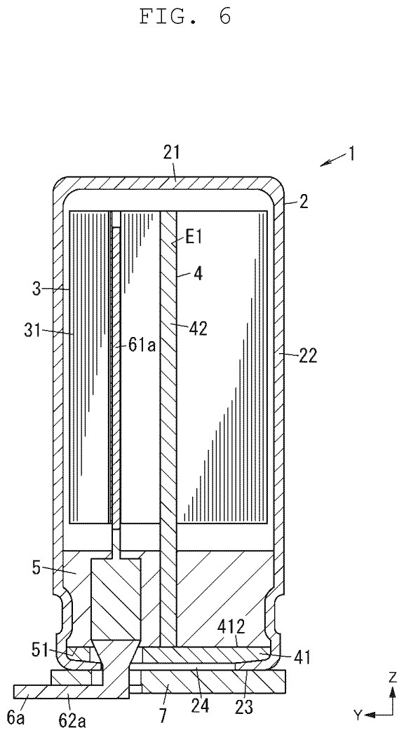

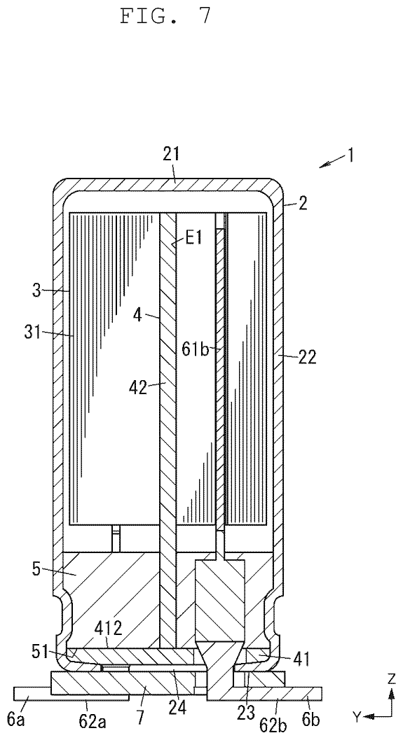

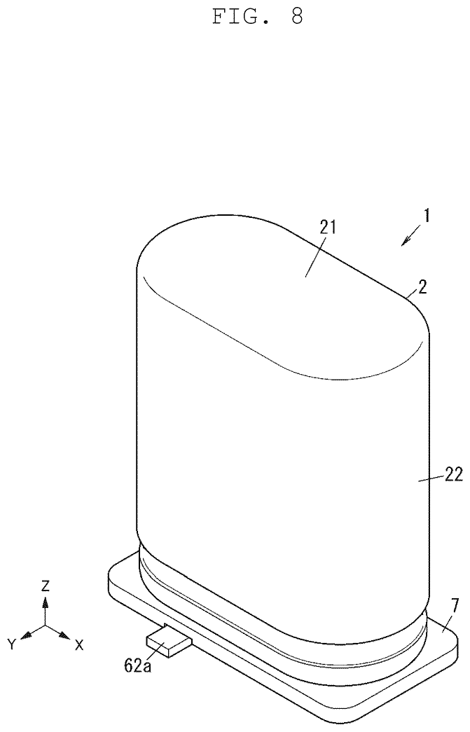

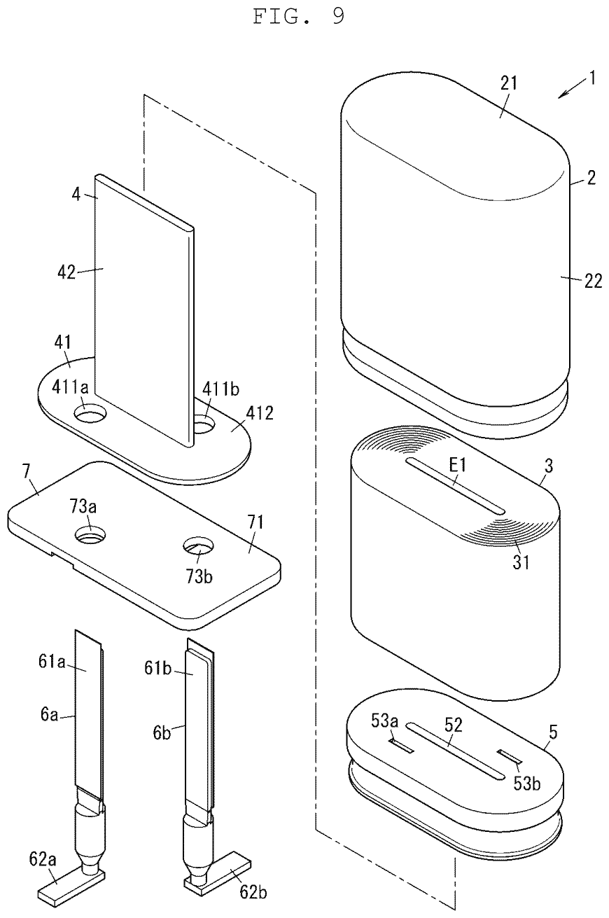

Hereinafter, a detailed configuration of electrolytic capacitor 1 of the present exemplary embodiment will be described with reference to FIGS. 1 to 11. In the following description, in FIG. 4, the third direction in which third peripheral region A3 and fourth peripheral region A4 face each other is the X-axis direction. In FIG. 4, the second direction in which first peripheral region A1 and second peripheral region A2 face each other is the Y-axis direction orthogonal to the X-axis direction. That is, in the present exemplary embodiment, the first direction and the second direction are orthogonal to each other, for example. In FIGS. 6 and 7, the first direction in which anode lead member 6a and cathode lead member 6b each extend is the Z-axis direction orthogonal to the X-axis direction and the Y-axis direction. That is, in the present exemplary embodiment, the third direction is orthogonal to the first direction and the second direction. Furthermore, a positive orientation in the X-axis direction is defined as a right side, a positive direction in the Y-axis direction is defined as a front side, and a positive direction in the Z-axis direction is defined as an upper side. However, these directions are merely examples, and are not intended to limit the direction of electrolytic capacitor 1 during use. Arrows indicating the “X-axis direction”, the “Y-axis direction”, and the “Z-axis direction” in the drawings are merely described for the sake of description, and are not substantial.

### (1-2-1) Overall Configuration

As illustrated in FIGS. 1 and 8 to 10, electrolytic capacitor 1 includes container 2, capacitor element 3, heat dissipation member 4, sealer 5, anode lead member 6a, cathode lead member 6b, and base plate 7.

### (1-2-2) Capacitor Element

As illustrated in FIG. 2, capacitor element 3 includes winding portion 31 in which anode foil 311, cathode foil 312, and, for example, two separators 313 are wound, and an electrolyte (not illustrated) held by winding portion 31. Here, FIG. 2 illustrates a state in which capacitor element 3 is partially developed.

Anode foil 311 includes a metal foil and a dielectric layer formed on a surface of this metal foil. Anode foil 311 is formed in a rectangular shape. The material of the metal foil of anode foil 311 is desirably a valve metal such as, for example, aluminum, tantalum, or niobium, or an alloy containing a valve metal.

Cathode foil 312 includes a metal foil such as aluminum. Cathode foil 312 is formed in a rectangular shape larger in outer shape than anode foil 311. The material of the metal foil included in cathode foil 312 may be the same as or different from the material of the metal foil included in anode foil 311.

Separator 313 is interposed between anode foil 311 and cathode foil 312 and holds the electrolyte. Separator 313 is formed in a rectangular shape larger in outer shape than each of anode foil 311 and cathode foil 312. Separator 313 is a nonwoven fabric containing, for example, cellulose fiber, kraft, polyethylene terephthalate, polyphenylene sulfide, nylon, aromatic polyamide, polyimide, polyamideimide, polyetherimide, rayon, hyaline, vinylon, aramid fiber, or the like.

The electrolyte held by separator 313 includes a solid electrolyte such as a conductive polymer or an electrolytic solution, and may include both the conductive polymer and the electrolytic solution. When a conductive polymer is used as the electrolyte, the electrolyte may be, for example, polypyrrole, polythiophene, polyaniline, derivatives thereof, and the like, and a dopant may be further added.

Anode foil 311, cathode foil 312, and two separators 313 are each formed in a long sheet shape.

Winding portion 31 is formed by winding anode foil 311, cathode foil 312, and two separators 313. Winding portion 31 is wound together with anode lead member 6a and cathode lead member 6b. An example of a formation method of winding portion 31 will be described below.

First, anode foil 311, cathode foil 312, and two separators 313 are stacked in order of separator 313, anode foil 311, separator 313, and cathode foil 312. At this time, part of anode lead member 6a (anode lead body 61a) is sandwiched between anode foil 311 and separator 313 to be electrically connected with anode foil 311, and part of cathode lead member 6b (cathode lead body 61b) is sandwiched between cathode foil 312 and separator 313 to be electrically connected with cathode foil 312.

Anode foil 311, cathode foil 312, and two separators 313 are wound around a winding core having a plate shape, for example, together with anode lead body 61a and cathode lead body 61b. Here, anode foil 311, cathode foil 312, two separators 313, anode lead body 61a, and cathode lead body 61b are wound such that anode lead body 61a and cathode lead body 61b protrude downward from the lower surface of winding portion 31.

After anode foil 311, cathode foil 312, and two separators 313 are wound, the winding core is removed to form winding portion 31. A space from which the winding core is removed as illustrated in FIG. 2 becomes space E1 having a slit shape penetrating winding portion 31 in the Z-axis direction.

An end of cathode foil 312 positioned in the outermost layer of winding portion 31 is fixed with, for example, fastening tape 314.

Winding portion 31 is impregnated with an electrolytic solution (electrolyte) after formation. Due to this, the electrolyte is held by separator 313.

Meanwhile, the formation method of winding portion 31 described above is an example, and winding portion 31 may be formed by another formation method.

As illustrated in FIG. 4, winding portion 31 includes first peripheral region A1 to fourth peripheral region A4 whose shapes viewed in the Z-axis direction are divided by reference lines L1 to L3, which are imaginary lines. Reference line L1 is a line parallel to the X-axis direction (third direction), and reference lines L2 and L3 are lines each parallel to the Y-axis direction.

First peripheral region A1 and second peripheral region A2 are regions facing each other in the Y-axis direction (second direction). Specifically, first peripheral region A1 and second peripheral region A2, each having a rectangular shape, for example, are line-symmetric with reference line L1 as a symmetry axis. Third peripheral region A3 and fourth peripheral region A4 are regions facing each other in the X-axis direction (third direction). Specifically, third peripheral region A3 and fourth peripheral region A4, each having a semicircular shape, for example, are line-symmetric with reference line L4, which is an imaginary line orthogonal to reference line L1, as a symmetry axis.

Here, the outer edge of first peripheral region A1 is smoothly continuous with the outer edges of third peripheral region A3 and fourth peripheral region A4. The outer edge of second peripheral region A2 is smoothly continuous with the outer edges of third peripheral region A3 and fourth peripheral region A4. That is, the shape of winding portion 31 as viewed in the Z-axis direction is, for example, an oval shape, and the length in the X-axis direction is larger than the length in the Y-axis direction. Note that there is a case where the sectional shape of winding portion 31 is not a perfect oval shape depending on the winding method or the like, and the shape may be slightly deformed from the oval shape. The shape of winding portion 31 as viewed in the Z-axis direction is not limited to an oval shape, and may be an elliptic shape having the X-axis direction as a major axis, for example, or may be a rectangular shape having the X-axis direction as a long direction.

### (1-2-3) Anode Lead Member and Cathode Lead Member

As illustrated in FIGS. 1 and 3 to 6, anode lead member 6a includes anode lead body 61a and anode lead terminal 62a.

As described above, anode lead body 61a is electrically connected to anode foil 311 and extends downward.

Anode lead terminal 62a is electrically and mechanically connected to anode lead body 61a, and functions as an external terminal. Anode lead terminal 62a is a member having a plate shape extending in a direction different from a downward direction in which anode lead body 61a extends. In the present exemplary embodiment, anode lead terminal 62a extends forward, for example. In the present exemplary embodiment, anode lead terminal 62a is formed by bending forward a part extending from a lower part of anode lead body 61a.

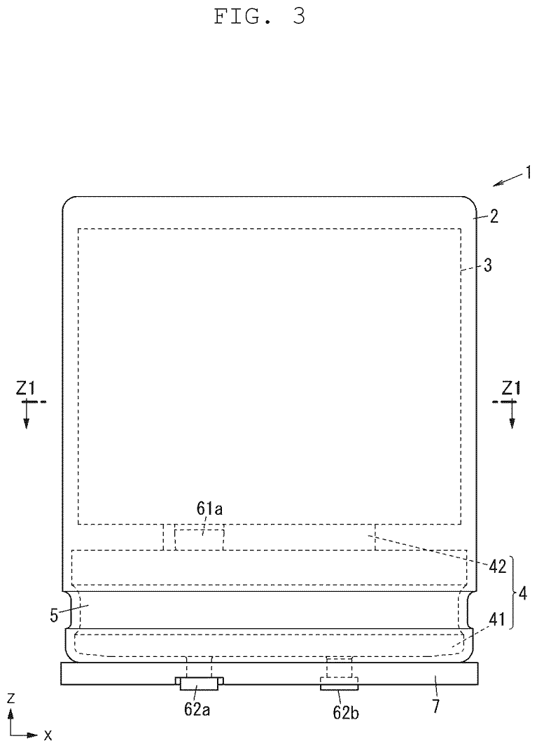

As illustrated in FIGS. 3 to 5 and 7, cathode lead member 6b includes cathode lead body 61b and cathode lead terminal 62b.

As described above, cathode lead body 61b is electrically connected to cathode foil 312 and extends downward.

Cathode lead terminal 62b is electrically and mechanically connected to cathode lead body 61b, and functions as an external terminal. Cathode lead terminal 62b is a member having a plate shape extending in a direction different from a downward direction in which cathode lead body 61b extends. In the present exemplary embodiment, cathode lead terminal 62b extends rearward, for example. In the present exemplary embodiment, cathode lead terminal 62b is formed by bending rearward a part extending from a lower part of cathode lead body 61b.

Anode lead terminal 62a and cathode lead terminal 62b are not limited to members having a plate shape and may be linear members.

As illustrated in FIG. 4, anode lead member 6a and cathode lead member 6b are arranged point-symmetrically with respect to center P1 of winding portion 31 when viewed in the Z-axis direction. Center P1 is an intersection of reference line L1 and reference line L4, for example. Anode lead member 6a and cathode lead member 6b are located, for example, in first peripheral region A1 and second peripheral region A2, respectively. Anode lead member 6a may be located in third peripheral region A3, or may be located over first peripheral region A1 and third peripheral region A3. Cathode lead member 6b may be located in fourth peripheral region A4 or may be located over second peripheral region A2 and fourth peripheral region A4.

Electrolytic capacitor 1 of the present exemplary embodiment is mounted on a substrate by joining lower surfaces of anode lead terminal 62a and cathode lead terminal 62b to the substrate with a joining material such as solder. In general, the above mounting method is called surface mounting.

### (1-2-4) Container

Container 2 is formed of, one or more types materials selected from the group consisting of, for example, aluminum, stainless steel, copper, iron, brass, and alloys thereof.

As illustrated in FIGS. 3 and 6 to 10, container 2 houses capacitor element 3, at least a part of anode lead body 61a, at least a part of cathode lead body 61b, sealer 5, and heat dissipation member 4. That is, container 2 houses winding portion 31.

The shape of container 2 as viewed in the Z-axis direction is, for example, an oval shape.

As illustrated in FIGS. 6 to 10, container 2 includes bottom 21, side 22, and drawing portion 23.

Bottom 21 is a member having a plate shape whose thickness direction is an up-down direction (Z-axis direction). The shape of bottom 21 as viewed in the Z-axis direction is, for example, an oval shape.

Side 22 is continuous with bottom 21 at the peripheral edge of bottom 21 and protrudes downward from the peripheral edge of bottom 21. Thus, the shape of side 22 when viewed in the Z-axis direction is an oval shape similarly to bottom 21.

Drawing portion 23 is a portion formed by drawing the lower end of side 22 inward. Specifically, drawing portion 23 is formed by performing a drawing process so as to contract the lower end of side 22 inward. Formation of drawing portion 23 by the drawing process is performed after container 2 houses capacitor element 3, at least a part of anode lead body 61a, at least a part of cathode lead body 61b, sealer 5, and heat dissipation member 4.

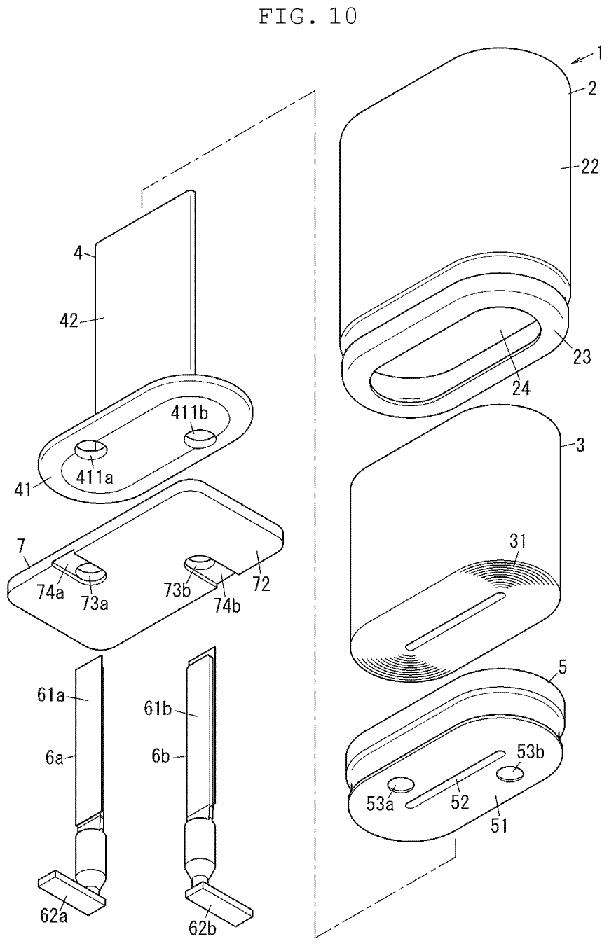

As illustrated in FIG. 10, container 2 includes opening 24 that opens downward. Opening 24 is surrounded by an inner peripheral edge of drawing portion 23. That is, opening 24 is formed by forming drawing portion 23 after capacitor element 3, at least a part of anode lead body 61a, at least a part of cathode lead body 61b, sealer 5, and heat dissipation member 4 are housed in container 2.

### (1-2-5) Sealer

As illustrated in FIGS. 6, 7, 9, and 10, sealer 5 is a member having a plate shape whose thickness direction is the Z-axis direction. Sealer 5 is an elastic component formed of, for example, a rubber material such as ethylene-propyleneterpolymer (EPT) or isobutylene-isoprenerubber (IIR), or a resin material such as an epoxy resin.

Sealer 5 is formed such that the shape of sealer 5 viewed in the Z-axis direction is slightly larger than the shape of the inner surface of side 22 in a state where sealer 5 is not housed in container 2. That is, the shape of sealer 5 viewed in the Z-axis direction is an oval shape having an area larger than the oval shape that is the shape of the inner surface of side 22.

Sealer 5 is housed in container 2 after capacitor element 3, at least a part of anode lead body 61a, and at least a part of cathode lead body 61b are housed in container 2. At this time, sealer 5 contracts with respect to the inner surface of side 22, and thus an elastic force is applied to side 22 in a state of being housed in container 2. Due to this, capacitor element 3, at least a part of anode lead body 61a, and at least a part of cathode lead body 61b are sealed in container 2.

After housing sealer 5, container 2 further houses heat dissipation member 4. Here, as described above, after heat dissipation member 4 is housed in container 2, drawing portion 23 and opening 24 are formed. Therefore, as illustrated in FIGS. 6 and 7, sealer 5 seals opening 24 from the external space.

Sealer 5 has exposed surface 51. Exposed surface 51 is a surface exposed from opening 24 before heat dissipation member 4 is housed in container 2.

As illustrated in FIGS. 9 and 10, sealer 5 is provided with through-holes 52, 53a, and 53b penetrating sealer 5 in the Z-axis direction. Through-hole 52 is a slit-shaped space into which column portion 42 of heat dissipation member 4 is inserted. Anode lead member 6a is inserted into through-hole 53a. Cathode lead member 6b is inserted into through-hole 53b.

### (1-2-6) Heat Dissipation Member

Heat dissipation member 4 dissipates heat generated inside container 2. More specifically, heat dissipation member 4 dissipates heat generated by current flowing through capacitor element 3 inside container 2 to the outside.

As illustrated in FIGS. 9 and 10, heat dissipation member 4 includes plate portion 41 and column portion 42.

Plate portion 41 is a member having a plate shape whose thickness direction is the Z-axis direction. The shape of plate portion 41 as viewed in the Z-axis direction is, for example, an oval shape.

Plate portion 41 is provided with through-holes 411a and 411b penetrating plate portion 41 in the Z-axis direction. Through-holes 411a and 411b are provided to be aligned with through-holes 53a and 53b, respectively, of sealer 5 in the Z-axis direction. Anode lead member 6a is inserted into through-hole 411a through through-hole 53a, and cathode lead member 6b is inserted into through-hole 411b through through-hole 53b.

Column portion 42 is a member having a plate shape whose thickness direction is the Y-axis direction (front-rear direction), for example.

Column portion 42 extends from one surface 412 of plate portion 41, which is an upper surface of plate portion 41. More specifically, column portion 42 extends upward from a center of one surface 412 of plate portion 41 in the Y-axis direction.

As illustrated in FIGS. 6 and 7, column portion 42 is inserted into winding portion 31. Specifically, column portion 42 is inserted into space E1 (see FIG. 2) provided in through-hole 52 of sealer 5 and winding portion 31. Here, the thickness of column portion 42 is formed to be substantially the same as or slightly larger than the width in the Y-axis direction of space E1. This brings at least a part of column portion 42 in contact with the inner surface of winding portion 31.

As illustrated in FIGS. 6 and 7, heat dissipation member 4 is disposed such that one surface 412 of plate portion 41 is in contact with exposed surface 51 of sealer 5.

As described above, after capacitor element 3, at least a part of anode lead body 61a, at least a part of cathode lead body 61b, sealer 5, and heat dissipation member 4 are housed in container 2, drawing portion 23 is formed by the drawing process. Here, the inner surface of drawing portion 23 and plate portion 41 are in contact with each other. In other words, plate portion 41 is in contact with container 2 by the drawing process. This enables heat dissipation member 4 to dissipate heat generated inside container 2 from the outer surface of container 2 via drawing portion 23. Since plate portion 41 of heat dissipation member 4 supports sealer 5 from below, the strength of sealer 5 can be reinforced. Thus, the height dimension in the up-down direction of sealer 5 necessary for securing the strength of sealer 5 is reduced, and an effect of being able to reduce the height dimension in the up-down direction of sealer 5 is achieved. As a result, capacitor element 3 housed in container 2 can be enlarged, and the electrostatic capacity of electrolytic capacitor 1 can be increased. When the electrostatic capacity is the same, by reducing the height dimension in the up-down direction of sealer 5, it is possible to reduce the height of electrolytic capacitor 1.

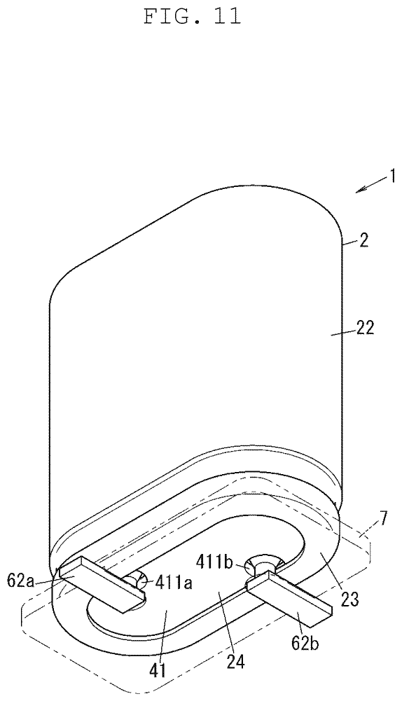

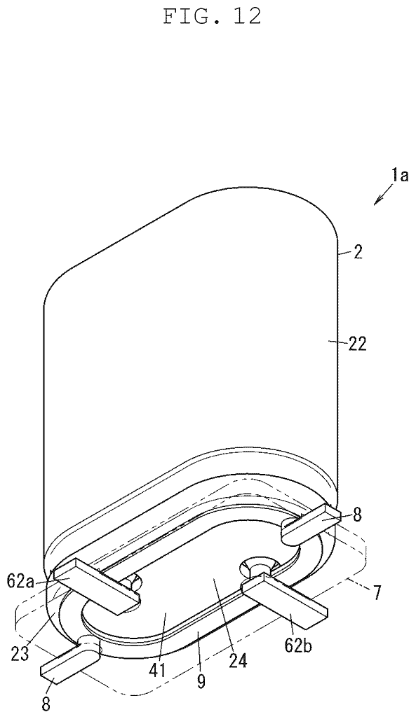

In a state where drawing portion 23 is formed, plate portion 41 covers at least a part of opening 24 when viewed from below. Specifically, as illustrated in FIG. 11, plate portion 41 covers opening 24 by a part other than through-holes 411a and 411b.

In consideration of contact with anode foil 311, an insulation film is formed on the surface of column portion 42 by means such as, for example, vapor deposition or sputtering. The thickness of the insulation film is preferably greater than or equal to 10 nm and less than or equal to 500 nm. Applying the surface of column portion 42 with an insulation treatment secures insulation at heat dissipation member 4, but insulation may be secured at capacitor element 3. Separator 313 may be wound excessively inside winding portion 31 such that column portion 42 and separator 313 come into contact with each other when column portion 42 is inserted into winding portion 31, for example. As a result, when column portion 42 is inserted into winding portion 31, column portion 42 and anode foil 311 can be prevented from coming into contact with each other, and insulation can be secured at capacitor element 3.

Heat dissipation member 4 is formed of a material having a thermal conductivity of greater than or equal to 155 W/m·K. Due to this, electrolytic capacitor 1 has an advantage of being able to more efficiently dissipate heat generated inside. The “thermal conductivity” mentioned here is a physical quantity that defines ease of heat transfer by heat conduction, which is a phenomenon in which heat moves from a high-temperature part to a low-temperature part in a solid. In particular, heat dissipation member 4 is preferably formed of a material having a thermal conductivity of greater than or equal to 220 W/m·K.

Heat dissipation member 4 is formed of a material higher in Young's modulus than sealer 5. By this, when the internal pressure of container 2 increases, for example, deformation of sealer S is suppressed because sealer 5 is supported from below by heat dissipation member 4 having a Young's modulus higher than that of sealer 5. For example, when sealer 5 is made of a rubber material, the Young's modulus of sealer 5 is in a range about from 0.1 GPa to 0.3 GPa, inclusive. That is, when sealer 5 is made of a rubber material, heat dissipation member 4 is formed of a material having a Young's modulus higher than that of sealer 5 having a Young's modulus in a range about from 0.1 GPa to 0.3 GPa, inclusive.

In particular, heat dissipation member 4 is preferably formed of a material having a Young's modulus of greater than or equal to 1 GPa and less than or equal to 500 GPa. In this case, there is also an advantage of being able to suppress vibration in the horizontal direction of capacitor element 3. The “Young's modulus” mentioned here is a proportional constant of strain and stress in one direction, and is a value that defines how much the material is deformed when applied with a certain stress. Here, a material having a higher Young's modulus is less likely to be deformed, and a material having a lower Young's modulus is more likely to be deformed.

The material of heat dissipation member 4 is, for example, aluminum, copper, a stainless alloy, ceramic, or the like.

### (1-2-7) Base Plate

As illustrated in FIGS. 9 and 10, base plate 7 is a member having a plate shape whose thickness direction is the Z-axis direction. Specifically, the shape of base plate 7 is a plate shape formed in a rectangular shape with four rounded corners. Base plate 7 has an X-axis direction as a long direction, for example, and a Y-axis direction as a short direction.

Base plate 7 has electrical insulation. The material constituting base plate 7 is a synthetic resin material such as polyphenylene sulfide (PPS) or polyphthalamide (PPA).

Base plate 7 has attachment surface 71 and mount surface 72. In the present exemplary embodiment, attachment surface 71 is an upper surface of base plate 7, and mount surface 72 is a lower surface of base plate 7. Attachment surface 71 is attached with drawing portion 23 of container 2. Mount surface 72 is a surface facing the substrate when electrolytic capacitor 1 is mounted on the substrate.

Base plate 7 is provided with through-holes 73a and 73b penetrating base plate 7 in the Z-axis direction. Through-holes 73a and 73b are provided to be aligned with through-holes 411a and 411b, respectively, in the Z-axis direction. Anode lead member 6a is inserted into through-hole 73a through through-hole 411a, and cathode lead member 6b is inserted into through-hole 73b through through-hole 411b.

As illustrated in FIG. 10, mount surface 72 is provided with lead storage grooves 74a and 74b. Lead storage groove 74a is coupled to through-hole 73a and houses anode lead terminal 62a. Lead storage groove 74b is coupled to through-hole 73b and houses cathode lead terminal 62b.

### (1-3) Modification

Hereinafter, a modification of the first exemplary embodiment will be described. Meanwhile, components common to those of the first exemplary embodiment are denoted by the same reference marks, and the description thereof is appropriately omitted. Each configuration of the modification described below can be applied by being appropriately combined with each configuration described in the first exemplary embodiment.

### (1-3-1) First Modification

As illustrated in FIG. 12, electrolytic capacitor 1a of the first modification is different from that of the first exemplary embodiment in further including, for example, two dummy terminals 8 fixed to the substrate mounted with container 2. The number of dummy terminals 8 may be one or three or more. Electrolytic capacitor 1a further includes auxiliary heat dissipation member 9.

Two dummy terminals 8 are in indirect contact with container 2 and heat dissipation member 4. Specifically, two dummy terminals 8 are in indirect contact with container 2 and heat dissipation member 4 via auxiliary heat dissipation member 9. That is, auxiliary heat dissipation member 9 is in contact with each of container 2, heat dissipation member 4, and two dummy terminals 8. Note that it is not essential that two dummy terminals 8 are in contact with both container 2 and heat dissipation member 4, and two dummy terminals 8 may be in contact with at least one of container 2 or heat dissipation member 4. Two dummy terminals 8 may be in direct contact with at least one of container 2 or heat dissipation member 4.

Similarly to heat dissipation member 4, dummy terminal 8 is preferably formed of a material having a thermal conductivity of greater than or equal to 155 W/m·K, and more preferably formed of a material having a thermal conductivity of greater than or equal to 220 W/m·K.

Auxiliary heat dissipation member 9 is a member that brings container 2 and base plate 7 into thermal contact with each other. As illustrated in FIG. 12, auxiliary heat dissipation member 9 of the first modification brings drawing portion 23 of container 2 and base plate 7 into thermal contact with each other. Thus, in electrolytic capacitor 1a, the heat generated in container 2 and conducted to container 2 is transferred to auxiliary heat dissipation member 9, base plate 7, dummy terminal 8, and the substrate in this order and dissipated. That is, auxiliary heat dissipation member 9 forms a path through which heat generated inside container 2 is transferred from container 2 to the substrate.

Auxiliary heat dissipation member 9 is an annular plate member. More specifically, auxiliary heat dissipation member 9 is an annular plate member whose outer shape is an oval shape that fits opening 24. Auxiliary heat dissipation member 9 is fitted to opening 24 and disposed such that the outer periphery is in contact with the inner periphery of drawing portion 23 and the upper surface is in contact with plate portion 41 of heat dissipation member 4. Note that auxiliary heat dissipation member 9 may bring container 2 and base plate 7 into thermal contact with each other, and the shape of auxiliary heat dissipation member 9 or the position where auxiliary heat dissipation member 9 is disposed is not limited to that in the above aspect.

Auxiliary heat dissipation member 9 of the present exemplary embodiment may be integrated with container 2 by welding. Auxiliary heat dissipation member 9 may be integrated with container 2 by an adhesive member such as a thermal interface material (TIM) sheet or grease having thermal conductivity. As a result, there is an advantage that adhesion between container 2 and auxiliary heat dissipation member 9 can be improved, and thermal conductivity from container 2 to auxiliary heat dissipation member 9 can be improved. In this case, the thermal conductivity of the adhesive member is preferably greater than or equal to 1 W/m·K, and in particular, the adhesive member is more preferably formed of a material having a thermal conductivity of greater than or equal to 10 W/m·K.

Auxiliary heat dissipation member 9 is a metal material having thermal conductivity, for example. The metal material is, for example, aluminum, copper, or a stainless alloy. In this case, similarly to heat dissipation member 4 and dummy terminal 8, auxiliary heat dissipation member 9 is preferably formed of a material having a thermal conductivity of greater than or equal to 155 W/m·K, and more preferably formed of a material having a thermal conductivity of greater than or equal to 220 W/m·K.

Two dummy terminals 8 are provided on the lower surface of auxiliary heat dissipation member 9. Two dummy terminals 8 each extend in a direction orthogonal to the direction in which anode lead terminal 62a and cathode lead terminal 62b extend. Two dummy terminals 8 extend in directions opposite to each other in the X-axis direction, for example. The number of dummy terminals 8 is not limited to two, and may be one or three or more.

According to this configuration, dummy terminal 8 and auxiliary heat dissipation member 9 function as a transfer path through which the heat generated in capacitor element 3 and conducted to container 2 is transferred from container 2 and heat dissipation member 4 to the substrate. As a result, an effect that the heat generated in container 2 is easily dissipated to the substrate is achieved. That is, electrolytic capacitor 1a has an advantage of being able to more efficiently dissipate heat generated inside.

Although auxiliary heat dissipation member 9 illustrated in FIG. 12 is in contact with each of container 2, heat dissipation member 4, and dummy terminal 8, it may be in contact with each of dummy terminal 8 and at least one of container 2 or heat dissipation member 4. That is, dummy terminal 8 may be in contact with at least one of container 2 or heat dissipation member 4 via auxiliary heat dissipation member 9.

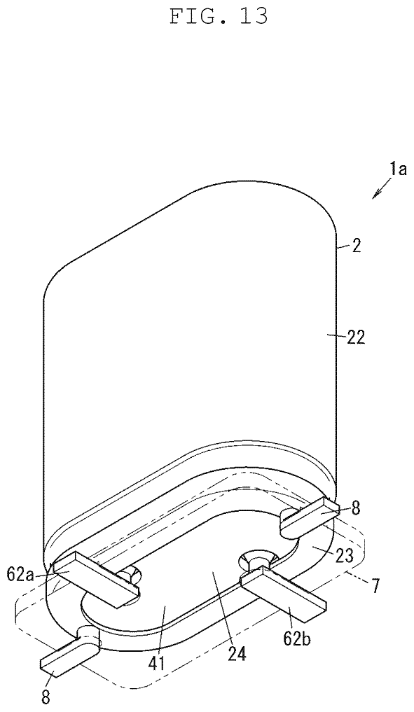

Dummy terminal 8 may be in direct contact with at least one of container 2 or heat dissipation member 4 not via auxiliary heat dissipation member 9. That is, dummy terminal 8 may be in direct or indirect contact with at least one of container 2 or heat dissipation member 4. For example, as illustrated in FIG. 13, dummy terminal 8 may be provided directly on drawing portion 23 of container 2. In this case, in electrolytic capacitor 1a, heat generated inside container 2 and conducted to container 2 is conducted to the substrate via dummy terminal 8 and dissipated.

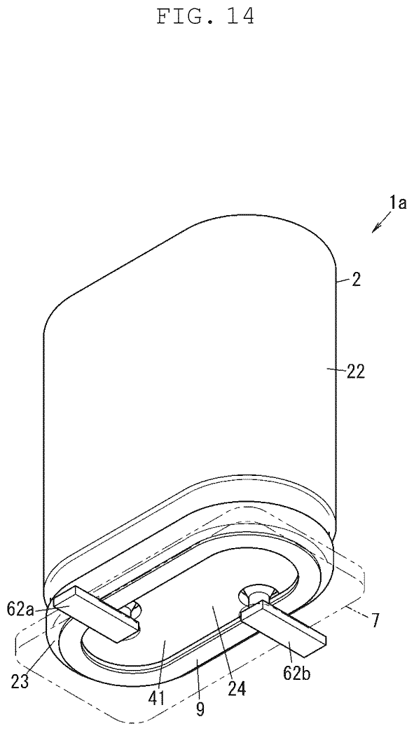

As illustrated in FIG. 14, container 2 and base plate 7 may be brought into thermal contact with each other without using dummy terminal 8.

### (1-3-2) Second Modification

As illustrated in FIG. 15, electrolytic capacitor 1b according to the second modification is different from the first exemplary embodiment and the first modification in including first anode lead member 6a, which is anode lead member 6a in the first exemplary embodiment, and second anode lead member 60a.

Second anode lead member 60a is connected to anode foil 311 and extends in the Z-axis direction. Second anode lead member 60a is arranged to face first anode lead member 6a in the Y-axis direction. First anode lead member 6a and second anode lead member 60a are arranged symmetrically with reference line L1, for example, as a symmetry axis.

According to the above configuration, an insulation distance between second anode lead member 60a and cathode lead member 6b can be secured. When first anode lead member 6a, second anode lead member 60a, and cathode lead member 6b are each joined to the substrate with a joining material such as solder, and thus electrolytic capacitor 1b is mounted on the substrate, the three lead members (first anode lead member 6a, second anode lead member 60a, and cathode lead member 6b) are applied with the load of electrolytic capacitor 1b. This reduce a load applied to one lead member and can improve stability of electrolytic capacitor 1b as compared with the case where two lead members (anode lead member 6a and cathode lead member 6b) are joined to the substrate as in the first exemplary embodiment.

### (1-3-3) Third Modification

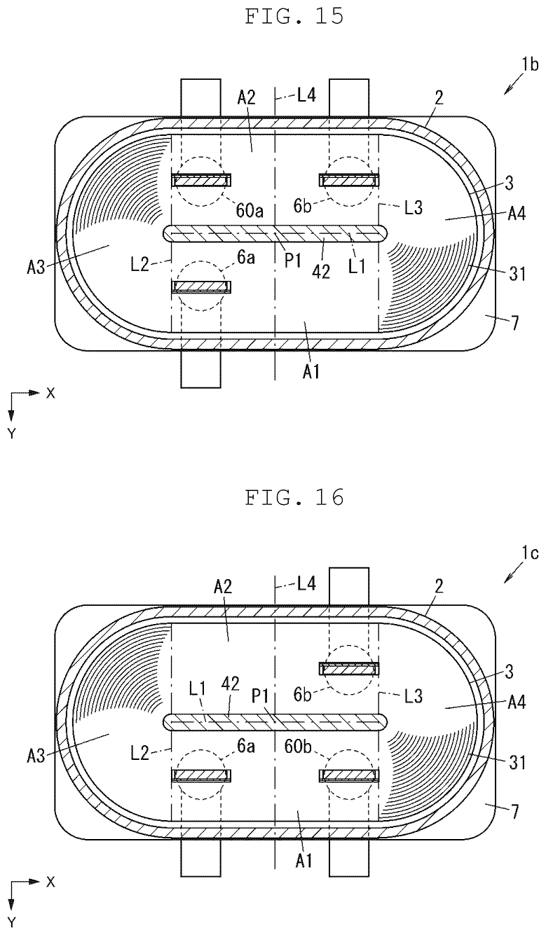

As illustrated in FIG. 16, electrolytic capacitor 1c according to the third modification is different from the first exemplary embodiment and the first and second modifications in including first cathode lead member 6b, which is cathode lead member 6b in the first exemplary embodiment, and second cathode lead member 60b.

Second cathode lead member 60b is connected to cathode foil 312 and extends in the Z-axis direction. Second cathode lead member 60b is arranged to face first cathode lead member 6b in the Y-axis direction. First cathode lead member 6b and second cathode lead member 60b are arranged symmetrically with reference line L1, for example, as a symmetry axis.

According to the above configuration, an insulation distance between second cathode lead member 60b and anode lead member 6a can be secured. When first cathode lead member 6b, second cathode lead member 60b, and anode lead member 6a are joined to the substrate with a joining material such as solder, and thus electrolytic capacitor 1c is mounted on the substrate, the three lead members (first cathode lead member 6b, second cathode lead member 60b, and anode lead member 6a) are applied with the load of electrolytic capacitor 1c. This reduce a load applied to one lead member and can improve stability of electrolytic capacitor 1c as compared with the case where two lead members (anode lead member 6a and cathode lead member 6b) are joined to the substrate as in the first exemplary embodiment.

### (1-3-4) Other Modifications

Anode lead terminal 62a and cathode lead terminal 62b may be linear members extending downward. In this case, anode lead terminal 62a and cathode lead terminal 62b are inserted into a hole provided in the substrate and joined with a joining material such as solder, whereby electrolytic capacitor 1 is mounted on the substrate. In general, the above mounting method is called through-hole mounting or insertion mounting. When electrolytic capacitor 1 is subjected to through-hole mounting, it is not essential for electrolytic capacitor 1 to include base plate 7, and base plate 7 can be omitted as appropriate.

### (2) Second Exemplary Embodiment

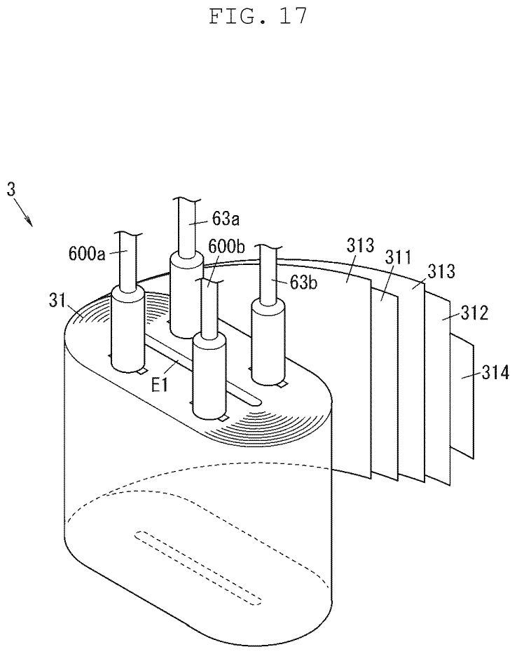

Hereinafter, details of electrolytic capacitor 10 of the present exemplary embodiment will be described with reference to FIGS. 17 to 19, focusing on differences from the first exemplary embodiment. In the following description, the same parts as those of the first exemplary embodiment are denoted by the same reference marks, and the description thereof may be omitted.

The present exemplary embodiment is different from the first exemplary embodiment in the following points.

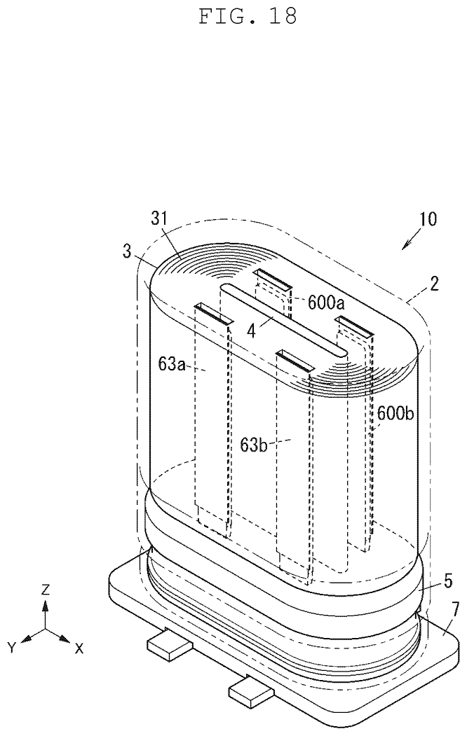

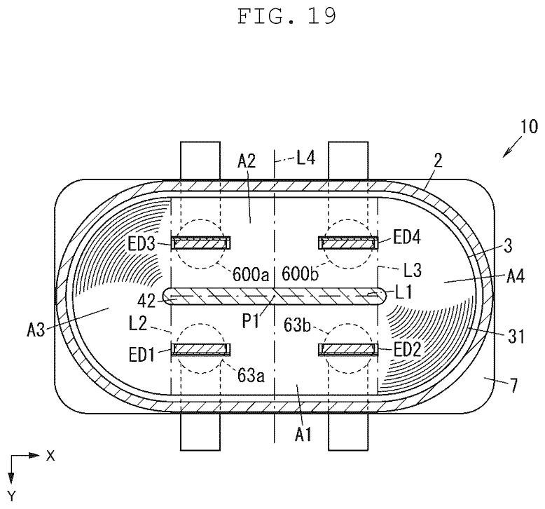

Electrolytic capacitor 10 includes winding portion 31, first anode lead member 63a, second anode lead member 600a, first cathode lead member 63b, and second cathode lead member 600b. Winding portion 31 includes anode foil 311 and cathode foil 312 that are wound. First anode lead member 63a and second anode lead member 600a are connected to anode foil 311 and each extend in the first direction (Z-axis direction in FIG. 18). First cathode lead member 63b and second cathode lead member 600b are connected to cathode foil 312 and each extend in the first direction. As illustrated in FIG. 19, winding portion 31 includes first peripheral region A1 and second peripheral region A2 whose shapes viewed in the first direction are opposed to each other in a second direction (Y-axis direction) intersecting the first direction, and third peripheral region A3 and fourth peripheral region A4 whose shapes viewed in the first direction are opposed to each other in a third direction (X-axis direction) intersecting the first direction and the second direction. The length of winding portion 31 in the third direction is larger than the length of winding portion 31 in the second direction.

As illustrated in FIG. 19, first anode lead member 63a is located at first end ED1 of first peripheral region A1 when viewed in the first direction. Here, first end ED1 is a boundary between first peripheral region A1 and third peripheral region A3. First anode lead member 63a being located at first end ED1 means at least a part of first anode lead member 63a being located at first end ED1 when viewed in the first direction (Z-axis direction).

First cathode lead member 63b is located at second end ED2 of first peripheral region A1 when viewed in the first direction. Here, second end ED2 is a boundary between first peripheral region A1 and fourth peripheral region A4. First cathode lead member 63b being located at second end ED2 means at least a part of first cathode lead member 63b being located at second end ED2 when viewed in the Z-axis direction.

Second anode lead member 600a is located at third end ED3, which is opposed to first end ED1, of second peripheral region A2 when viewed in the first direction. Here, third end ED3 is a boundary between second peripheral region A2 and third peripheral region A3. Second anode lead member 600a being located at third end ED3 means at least a part of second anode lead member 600a being located at third end ED3 when viewed in the Z-axis direction.

Second cathode lead member 600b is located at fourth end ED4, which is opposed to second end ED2, of second peripheral region A2 when viewed in the first direction. Here, fourth end ED4 is a boundary line between second peripheral region A2 and fourth peripheral region A4. Second cathode lead member 600b being located at fourth end ED4 means at least a part of second cathode lead member 600b being located at fourth end ED4 when viewed in the Z-axis direction.

First anode lead member 63a and second anode lead member 600a are arranged symmetrically with reference line L1, for example, as a symmetry axis. First cathode lead member 63b and second cathode lead member 600b are arranged symmetrically with reference line L1, for example, as a symmetry axis. Being arranged “line-symmetrically” is not limited to being arranged at strictly line-symmetric positions, and includes a state of being arranged at positions slightly shifted from line-symmetric positions.

First anode lead member 63a and first cathode lead member 63b are arranged symmetrically with reference line L4, for example, as a symmetry axis. Second anode lead member 600a and second cathode lead member 600b are arranged symmetrically with reference line L4, for example, as a symmetry axis.

According to the above configuration, an insulation distance between first anode lead member 63a and second anode lead member 600a and first cathode lead member 63b and second cathode lead member 600b can be secured. When first anode lead member 63a, second anode lead member 600a, first cathode lead member 63b, and second cathode lead member 600b are joined to the substrate with a joining material such as solder, and thus electrolytic capacitor 10 is mounted on the substrate, the four lead members (first anode lead member 63a, second anode lead member 600a, first cathode lead member 63b, and second cathode lead member 600b) are applied with the load of electrolytic capacitor 10. This reduce a load applied to one lead member and can improve stability (vibration resistance) of electrolytic capacitor 10 against vibration as compared with the case where two lead members (anode lead member 6a and cathode lead member 6b) are joined to the substrate as in the first exemplary embodiment. First anode lead member 63a, first cathode lead member 63b, second anode lead member 600a, and second cathode lead member 600b can be disposed in a well-balanced manner, and thus the center of gravity of electrolytic capacitor 10 gets close to center P1, enabling stability (vibration resistance) against vibration of electrolytic capacitor 10 to be secured.

### (3) Third Exemplary Embodiment

### (3-1) Outline

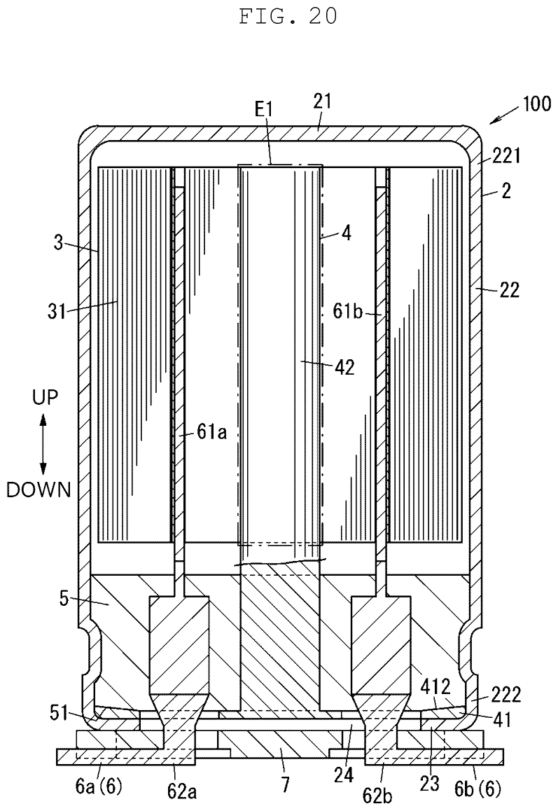

Hereinafter, an outline of electrolytic capacitor 100 according to the present exemplary embodiment will be described with reference to FIG. 20.

As illustrated in FIG. 20, electrolytic capacitor 100 according to the present exemplary embodiment includes capacitor element 3, container 2, and heat dissipation member 4. Capacitor element 3 includes winding portion 31 in which an anode foil and a cathode foil are wound. Container 2 houses capacitor element 3. Heat dissipation member 4 dissipates heat generated inside container 2. Heat dissipation member 4 includes plate portion 41 having a plate shape and column portion 42 extending from one surface 412 of plate portion 41. Column portion 42 is inserted into winding portion 31. Plate portion 41 is in contact with container 2.

In electrolytic capacitor 100 of the present exemplary embodiment, plate portion 41 and column portion 42 of heat dissipation member 4 function as conduction paths through which heat generated in container 2 is conducted from the inside of container 2 to container 2. As a result, the heat generated inside container 2 is conducted to container 2 and easily dissipated to the periphery of container 2.

As described above, electrolytic capacitor 100 of the present exemplary embodiment has an advantage that heat generated inside can be efficiently dissipated.

### (3-2) Detailed Configuration

### (3-2-1) Overall Configuration

Hereinafter, a detailed configuration of electrolytic capacitor 100 of the present exemplary embodiment will be described with reference to FIGS. 20 to 24. In the following description, parts similar to those in the first exemplary embodiment are denoted by the same reference marks, and the description thereof may be omitted.

As illustrated in FIGS. 20 to 22, electrolytic capacitor 100 includes capacitor element 3, container 2, heat dissipation member 4, sealer 5, a pair of lead members 6, and base plate 7.

In the following description, as illustrated in FIG. 20, a direction in which container 2 and base plate 7 are aligned is defined as an up-down direction, container 2 side as viewed from base plate 7 is defined as an upper side, and of base plate 7 side as viewed from container 2 is defined as a lower side.

### (3-2-2) Capacitor Element

Capacitor element 3 includes winding portion 31 in which an anode foil and a cathode foil are wound. Capacitor element 3 of the present exemplary embodiment includes winding portion 31 in which an anode foil, a cathode foil, and a separator are wound. In other words, capacitor element 3 of the present exemplary embodiment includes winding portion 31 in which the anode foil, the cathode foil, and the separator are layered and wound.

The anode foil, the cathode foil, and the separator are each formed in a long sheet shape. That is, winding portion 31 has the anode foil, the cathode foil, and the separator that are wound in a roll shape in an overlapping state.

The anode foil includes a metal foil and a dielectric layer formed on a surface of this metal foil. The material of the metal foil of the anode foil is desirably a valve metal such as, for example, aluminum, tantalum, or niobium, or an alloy containing a valve metal.

The cathode foil includes a metal foil such as aluminum. The material of the metal foil of the cathode foil may be the same as the material of the metal foil of the anode foil.

The separator is interposed between the anode foil and the cathode foil and holds an electrolyte. The separator is a nonwoven fabric containing, for example, cellulose fiber, kraft, polyethylene terephthalate, polyphenylene sulfide, nylon, aromatic polyamide, polyimide, polyamideimide, polyetherimide, rayon, hyaline, vinylon, aramid fiber, or the like. As the electrolyte, a solid electrolyte such as conductive polymer or an electrolytic solution can be used, for example. Otherwise, a conductive polymer and an electrolytic solution may both be used. When a conductive polymer is used as the electrolyte, the electrolyte may be, for example, polypyrrole, polythiophene, polyaniline, derivatives thereof, and the like, and a dopant may be further added.

As illustrated in FIGS. 20, 23, and 24, capacitor element 3 further includes space E1 surrounded by winding portion 31. Space E1 is formed by, for example, extracting a shaft that is caught when the anode foil, the cathode foil, and the separator are wound. Space E1 of the present exemplary embodiment has a cylindrical shape.

As illustrated in FIG. 20, the anode foil, the cathode foil, and the separator are wound around winding portion 31 with a part of the pair of lead members 6 interposed therebetween. More specifically, as illustrated in FIG. 20, in winding portion 31, the anode foil, the cathode foil, and the separator are wound with a part of anode lead body 61a described later and a part of cathode lead body 61b described later interposed therebetween.

### (3-2-3) Container

As illustrated in FIG. 20, container 2 houses capacitor element 3, heat dissipation member 4, and at least a part of the pair of lead members 6. More specifically, container 2 houses capacitor element 3, heat dissipation member 4, at least a part of anode lead body 61a described later, and at least a part of cathode lead body 61b described later.

As illustrated in FIGS. 20 to 24, container 2 includes bottom 21, side 22, and drawing portion 23. The shape of container 2 of the present exemplary embodiment is a circular shape in plan view as viewed in the upper direction.

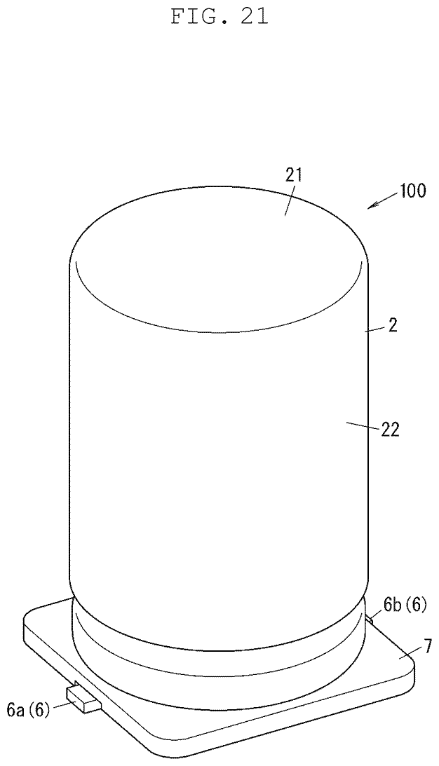

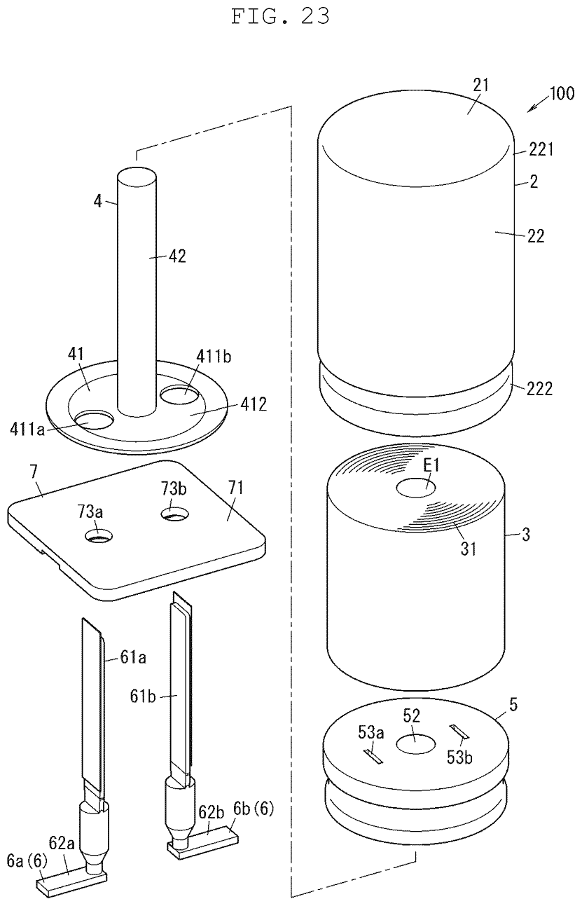

Bottom 21 has a plate shape. In the present exemplary embodiment, bottom 21 has a disk shape as illustrated in FIGS. 21 and 23. The thickness direction of bottom 21 is along the up-down direction as illustrated in FIG. 20.

Side 22 has a tubular shape. More specifically, as illustrated in FIG. 21, side 22 has a tubular shape protruding from the peripheral edge of bottom 21. In other words, one end 221 (see FIG. 20) of side 22 is mechanically connected to the peripheral edge of bottom 21. That is, one opening of side 22 having a tubular shape is closed by bottom 21. Side 22 of the present exemplary embodiment has a cylindrical shape protruding from circumferential edge of bottom 21.

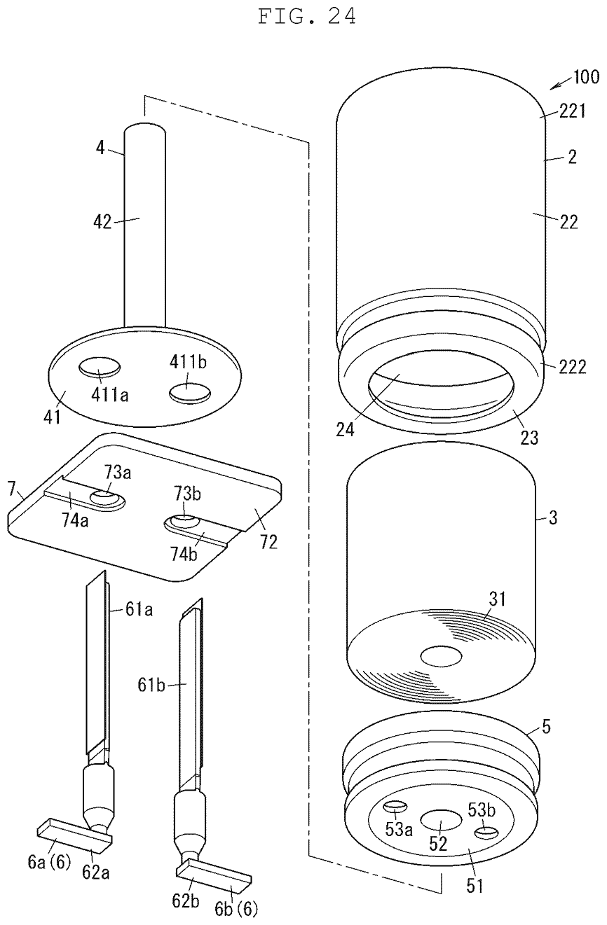

As illustrated in FIG. 20, drawing portion 23 is a portion in which other end 222 of side 22 not mechanically connected to bottom 21 is subjected to the drawing process inward. As illustrated in FIG. 24, drawing portion 23 of the present exemplary embodiment has an annular shape.

As illustrated in FIG. 24, container 2 further includes opening 24. Opening 24 is the other opening not closed by bottom 21 in side 22 having a tubular shape. Opening 24 is surrounded by drawing portion 23. Opening 24 of the present exemplary embodiment has a circular shape.

Container 2 is formed of, one or more types materials selected from the group consisting of, for example, aluminum, stainless steel, copper, iron, brass, and alloys thereof.

### (3-2-4) Sealer

As illustrated in FIG. 20, sealer 5 seals opening 24. Due to sealer 5 sealing opening 24, container 2 can house capacitor element 3, heat dissipation member 4, and at least a part of the pair of lead members 6.

The outer shape of sealer 5 is a shape that can be fitted into opening 24. That is, the outer shape of sealer 5 is a shape along the inner surface of side 22. In the present exemplary embodiment, sealer 5 has a cylindrical shape having a side surface along the inner surface of side 22.

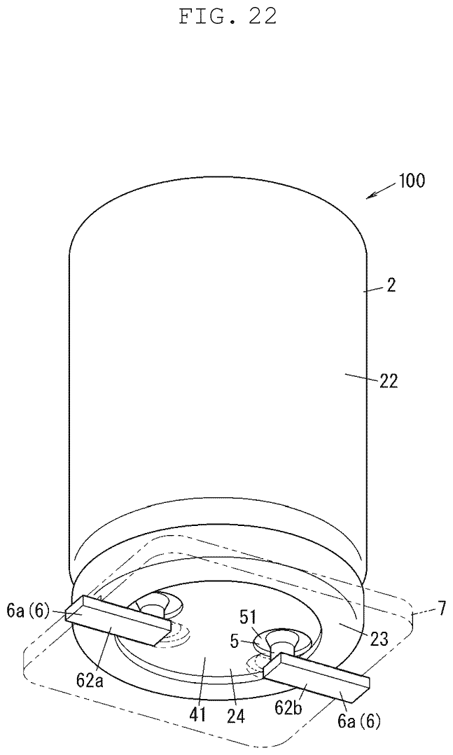

As illustrated in FIG. 22, sealer 5 has exposed surface 51 exposed from opening 24. More specifically, exposed surface 51 is a surface exposed from opening 24 when sealer 5 seals opening 24. Exposed surface 51 is an outer surface facing to the outside of container 2. Exposed surface 51 of the present exemplary embodiment is a lower surface of sealer 5. Exposed surface 51 has a circular shape.

As illustrated in FIGS. 23 and 24, sealer 5 further includes through-holes 52, 53a, and 53b. Column portion 42 of heat dissipation member 4 is inserted into through-hole 52. Anode lead member 6a is inserted into through-hole 53a, and cathode lead member 6b is inserted into through-hole 53a.

Sealer 5 is formed of, for example, a rubber material such as ethylene-propylene terpolymer (EPT) or isobutylene-isoprene rubber (IIR), or a resin material such as an epoxy resin.

### (3-2-5) Heat Dissipation Member

Heat dissipation member 4 dissipates heat generated inside container 2. More specifically, heat dissipation member 4 dissipates heat generated by current flowing through capacitor element 3 inside container 2.

As illustrated in FIGS. 20, 23, and 24, heat dissipation member 4 includes plate portion 41 and column portion 42.

Plate portion 41 has a plate shape. Plate portion 41 of the present exemplary embodiment has a disk shape covering the entirety of opening 24. Plate portion 41 of the present exemplary embodiment is in contact with container 2 by the drawing process. More specifically, plate portion 41 of the present exemplary embodiment is in contact with container 2 by being fixed by drawing portion 23.

As illustrated in FIG. 20, heat dissipation member 4 is disposed in contact with exposed surface 51 of sealer 5. More specifically, plate portion 41 is disposed such that one surface 412 of plate portion 41 is in contact with exposed surface 51 of sealer 5. In the present exemplary embodiment, one surface 412 of plate portion 41 is an upper surface of plate portion 41. That is, plate portion 41 of the present exemplary embodiment is disposed to be sandwiched between exposed surface 51 of sealer 5 and the inner surface of drawing portion 23.

As illustrated in FIGS. 23 and 24, plate portion 41 has through-holes 411a and 411b. Anode lead member 6a is inserted into through-hole 411a, and cathode lead member 6b is inserted into through-hole 411b.

As illustrated in FIGS. 20 and 23, column portion 42 extends from one surface 412 of plate portion 41. More specifically, column portion 42 extends upward from a center of one surface 412 of plate portion 41. In the present exemplary embodiment, column portion 42 extends upward from the center of plate portion 41 having a disk shape.

Column portion 42 is inserted into winding portion 31. In the present exemplary embodiment, as illustrated in FIG. 20, column portion 42 is inserted into space E1 surrounded by winding portion 31.

Column portion 42 of the present exemplary embodiment has a cylindrical shape. More specifically, column portion 42 of the present exemplary embodiment has a cylindrical shape having a diameter substantially the same as or slightly smaller than the inner diameter of space E1. That is, column portion 42 is in contact with the inner surface of winding portion 31. The surface of column portion 42 is subjected to an insulation treatment in consideration of contact with the anode foil. An insulation film is formed on the surface of column portion 42, for example, by means of vapor deposition, sputtering, or the like. The thickness of the insulation film is preferably greater than or equal to 10 nm and less than or equal to 500 nm from the viewpoint of obtaining insulating characteristics.

Applying the surface of column portion 42 with an insulation treatment secures insulation at heat dissipation member 4, but insulation may be secured at capacitor element 3. For example, the separator may be wound excessively inside winding portion 31 such that column portion 42 and the separator come into contact with each other when column portion 42 is inserted into winding portion 31. As a result, when column portion 42 is inserted into winding portion 31, column portion 42 and the anode foil can be prevented from coming into contact with each other, and insulation can be secured at capacitor element 3.

As the material of heat dissipation member 4, the same material as that of the first exemplary embodiment can be used. That is, heat dissipation member 4 of the present exemplary embodiment is formed of a material having a thermal conductivity of greater than or equal to 155 W/m·K and a Young's modulus of greater than or equal to 1 GPa and less than or equal to 500 GPa. For example, the material of heat dissipation member 4 is, for example, aluminum, copper, a stainless alloy, or ceramic.

### (3-2-6) Lead Member

When electrolytic capacitor 100 is mounted on the substrate, the pair of lead members 6 electrically connect the anode foil and the cathode foil of capacitor element 3, respectively, to the substrate mounted with electrolytic capacitor 100. Of the pair of lead members 6, lead member 6 electrically connected to the anode foil serves as anode lead member 6a, and lead member 6 electrically connected to the cathode foil serves as cathode lead member 6b.

As illustrated in FIGS. 20, 23, and 24, anode lead member 6a includes anode lead body 61a and anode lead terminal 62a. Anode lead body 61a is electrically connected to the anode foil. As illustrated in FIG. 20, anode lead body 61a extends in the up-down direction. Anode lead terminal 62a is electrically and mechanically connected to anode lead body 61a, and functions as an external terminal. Anode lead terminal 62a is a plate member extending in a direction different from the direction in which anode lead body 61a extends. In the present exemplary embodiment, anode lead terminal 62a extends in a direction orthogonal to the direction in which anode lead body 61a extends. Anode lead terminal 62a may be a linear member extending in a direction different from the direction in which anode lead body 61a extends.

Similarly, as illustrated in FIGS. 20, 23, and 24, cathode lead member 6b includes cathode lead body 61b and cathode lead terminal 62b. Cathode lead body 61b is electrically connected to the cathode foil. As illustrated in FIG. 20, cathode lead body 61b extends in the up-down direction. Cathode lead terminal 62b is electrically and mechanically connected to cathode lead body 61b, and functions as an external terminal. Cathode lead terminal 62b is a plate member extending in a direction different from the direction in which cathode lead body 61b extends. In the present exemplary embodiment, cathode lead terminal 62b extends in a direction orthogonal to the direction in which cathode lead body 61b extends Cathode lead terminal 62b may be a linear member extending in a direction different from the direction in which cathode lead body 61b extends.

Anode lead terminal 62a and cathode lead terminal 62b extend in directions opposite to each other along the same direction.

Anode lead member 6a and cathode lead member 6b are arranged point-symmetrically with respect to the center of winding portion 31 when viewed in the direction in which anode lead terminal 62a extends.

Electrolytic capacitor 100 of the present exemplary embodiment is mounted on a substrate by soldering lower surfaces of anode lead terminal 62a and cathode lead terminal 62b to the substrate. In general, the above mounting method is called surface mounting.

### (3-2-7) Base Plate

Base plate 7 is a plate member that has electrical insulation. In the present exemplary embodiment, base plate 7 is a plate member having a quadrangular shape with rounded corners.

Base plate 7 has attachment surface 71 and mount surface 72. In the present exemplary embodiment, attachment surface 71 is an upper surface of base plate 7, and mount surface 72 is a lower surface of base plate 7. Attachment surface 71 is attached with container 2. In the present exemplary embodiment, as illustrated in FIG. 20, attachment surface 71 is in contact with drawing portion 23 of container 2. Mount surface 72 is a surface that comes into contact with the substrate when electrolytic capacitor 100 is mounted on the substrate.

As illustrated in FIG. 23, base plate 7 is provided with through-holes 73a and 73b. More specifically, through-holes 73a and 73b penetrate between attachment surface 71 and mount surface 72 in the up-down direction (thickness direction) of base plate 7. Anode lead member 6a is inserted into through-hole 73a, and cathode lead member 6b is inserted into through-hole 73b.

As illustrated in FIG. 24, mount surface 72 is provided with lead storage grooves 74a and 74b. Lead storage groove 74a is coupled to each through-hole 73a to house anode lead terminal 62a. Similarly, lead storage groove 74b is coupled to each through-hole 73b to house cathode lead terminal 62b.

Through-hole 73a is provided in the bottom surface of lead storage groove 74a on mount surface 72. Similarly, through-hole 73b is provided in the bottom surface of lead storage groove 74b on mount surface 72.

Through-hole 73a of base plate 7, through-hole 411a of plate portion 41, and through-hole 53a of sealer 5 are aligned in the up-down direction and coaxially positioned. Therefore, anode lead member 6a can be inserted into through-hole 73a of base plate 7, through-hole 411a of plate portion 41, and through-hole 53a of sealer 5 along the up-down direction.

Similarly, through-hole 73b of base plate 7, through-hole 411b of plate portion 41, and through-hole 53b of sealer 5 are aligned in the up-down direction and coaxially positioned. Therefore, cathode lead member 6b can be inserted into through-hole 73b of base plate 7, through-hole 411b of plate portion 41, and through-hole 53b of sealer 5 along the up-down direction.

### (3-3) Advantages

Electrolytic capacitor 100 includes capacitor element 3, container 2, and heat dissipation member 4. Capacitor element 3 includes winding portion 31 in which an anode foil and a cathode foil are wound. Container 2 houses capacitor element 3. Heat dissipation member 4 dissipates heat generated inside container 2. Heat dissipation member 4 includes plate portion 41 having a plate shape and column portion 42 extending from one surface 412 of plate portion 41. Column portion 42 is inserted into winding portion 31. Plate portion 41 is in contact with container 2.

According to this configuration, plate portion 41 and column portion 42 of heat dissipation member 4 function as conduction paths through which heat generated in capacitor element 3 is conducted from the inside of container 2 to container 2. As a result, an effect that the heat generated in container 2 is easily dissipated to container 2 is achieved. That is, electrolytic capacitor 100 has an advantage that heat generated inside can be efficiently dissipated.

According to this configuration, column portion 42 of heat dissipation member 4 holds capacitor element 3, and thus an effect of suppressing vibration of capacitor element 3 in the radial direction of winding portion 31 is achieved. As a result, electrolytic capacitor 100 also has an advantage that breakage of lead member 6 can be suppressed.

In electrolytic capacitor 100, column portion 42 has a cylindrical shape.

According to this configuration, an effect that an area where column portion 42 and winding portion 31 are in direct contact with each other is increased when column portion 42 is inserted into winding portion 31 is achieved. As a result, electrolytic capacitor 100 has an advantage of being able to more efficiently dissipate heat generated inside.

In electrolytic capacitor 100, plate portion 41 is mechanically connected to container 2 by the drawing process.

According to this configuration, an effect that plate portion 41 can be more reliably brought into contact with container 2 is achieved. As a result, it is possible to suppress a situation in which plate portion 41 is not in contact with container 2 and heat generated inside is hardly dissipated to container 2. In other words, there is an advantage that heat generated inside can be reliably dissipated to container 2.

Electrolytic capacitor 100 further includes sealer 5 that seals opening 24, and sealer 5 has exposed surface 51 exposed from opening 24. Plate portion 41 of heat dissipation member 4 is disposed in contact with exposed surface 51.

According to this configuration, heat dissipation member 4 can hold sealer 5 and reinforce the strength of sealer 5. Therefore, the height dimension in the up-down direction of sealer 5 necessary for securing the strength of sealer 5 is reduced, and an effect of being able to reduce the height dimension in the up-down direction of sealer S is achieved. As a result, there is an advantage that capacitor element 3 housed in container 2 can be enlarged, and the electrostatic capacity of electrolytic capacitor 100 can be increased.

Advantages of this configuration will be described by way of example. When plate portion 41 of heat dissipation member 4 is not disposed in contact with exposed surface 51, sealer 5 is designed to have a height dimension in the up-down direction of approximately 3.0 mm. However, when plate portion 41 of heat dissipation member 4 is disposed in contact with exposed surface 51, if the height dimension in the up-down direction of plate portion 41 is approximately 0.1 mm, the height dimension in the up-down direction of sealer 5 can be reduced to approximately 2.5 mm. Therefore, there is an advantage that the height dimension in the up-down direction of capacitor element 3 can be increased by about 0.4 mm, and the charge amount stored in electrolytic capacitor 100 can be increased.

On the other hand, according to this configuration, when the height dimension in the up-down direction of capacitor element 3 is not changed, there is also an advantage that the height dimension in the up-down direction of container 2 can be reduced and electrolytic capacitor 100 can be downsized.

### (3-4) Modification

The above-described exemplary embodiment is merely one of various exemplary embodiments of the present disclosure. The above-described exemplary embodiment can be variously changed in accordance with design and the like as long as the object of the present disclosure is achieved.

### (3-4-1) First Modification

In the above example, heat generated in container 2 is conducted from the inside of container 2 to container 2 to efficiently dissipate the heat. However, heat generated in container 2a may be conducted also to the substrate mounted with electrolytic capacitor 100a to more efficiently dissipate the heat.

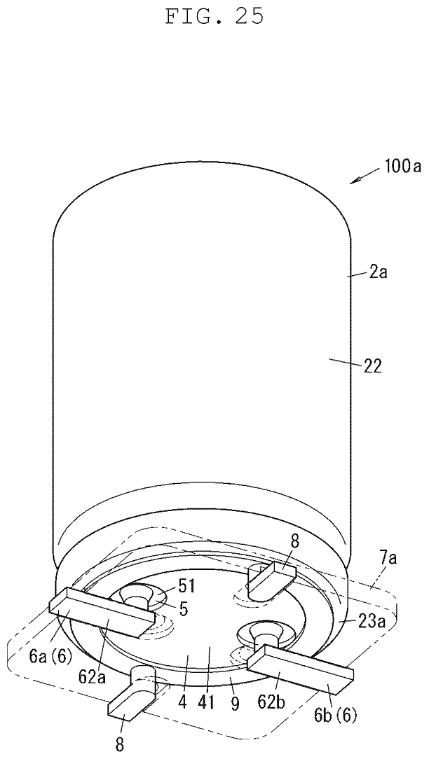

As illustrated in FIG. 25, electrolytic capacitor 100a may further include dummy terminal 8 fixed to the substrate mounted with container 2a, and auxiliary heat dissipation member 9 in contact with each of container 2a, heat dissipation member 4, and dummy terminal 8. Dummy terminal 8 is in contact with container 2a and heat dissipation member 4 via auxiliary heat dissipation member 9. Similarly to heat dissipation member 4, dummy terminal 8 is formed of a material having a thermal conductivity of greater than or equal to 155 W/m·K, and in particular, preferably formed of a material having a thermal conductivity of greater than or equal to 220 W/m·K.

Auxiliary heat dissipation member 9 is a member that brings container 2a and base plate 7a into thermal contact with each other. As illustrated in FIG. 25, auxiliary heat dissipation member 9 of the present exemplary embodiment brings drawing portion 23a of container 2a and base plate 7a into thermal contact with each other. Therefore, in electrolytic capacitor 100a, heat generated in container 2a and conducted to container 2a is conducted to auxiliary heat dissipation member 9, base plate 7a, dummy terminal 8, and the substrate in this order, and dissipated. That is, auxiliary heat dissipation member 9 creates a path through which heat generated inside container 2a is conducted from container 2a to the substrate.

Auxiliary heat dissipation member 9 is a plate member having an annular shape. More specifically, auxiliary heat dissipation member 9 is a plate member having an annular shape having an outer diameter substantially the same as the inner diameter of drawing portion 23a having an annular shape. Auxiliary heat dissipation member 9 is disposed with the outer periphery of auxiliary heat dissipation member 9 being in contact with the inner periphery of drawing portion 23a and with the upper surface of auxiliary heat dissipation member 9 being in contact with plate portion 41 of heat dissipation member 4. Auxiliary heat dissipation member 9 may bring container 2a and base plate 7a into thermal contact with each other, and the shape of auxiliary heat dissipation member 9 or the position where auxiliary heat dissipation member 9 is disposed is not limited.

Auxiliary heat dissipation member 9 of the present exemplary embodiment may be integrated with container 2a by welding. Auxiliary heat dissipation member 9 may be integrated with container 2a by an adhesive member such as a thermal interface material (TIM) sheet or grease having thermal conductivity. As a result, there is an advantage that adhesion between container 2a and auxiliary heat dissipation member 9 can be improved, and thermal conductivity from container 2a to auxiliary heat dissipation member 9 can be improved. In this case, the thermal conductivity of the adhesive member is preferably greater than or equal to 1 W/m·K, and in particular, the adhesive member is more preferably formed of a material having a thermal conductivity of greater than or equal to 10 W/m·K.

Auxiliary heat dissipation member 9 may be a metal material having thermal conductivity. The metal material is, for example, aluminum, copper, or a stainless alloy. In this case, similarly to heat dissipation member 4 and dummy terminal 8, auxiliary heat dissipation member 9 is preferably formed of a material having a thermal conductivity of greater than or equal to 155 W/m·K, and in particular, preferably formed of a material having a thermal conductivity of greater than or equal to 220 W/m·K.

Dummy terminal 8 is provided on the lower surface of auxiliary heat dissipation member 9. Each of two dummy terminals 8 extends in a direction intersecting the direction in which anode lead terminal 62a and cathode lead terminal 62b extend. More specifically, each of two dummy terminals 8 extends in a direction orthogonal to the direction in which anode lead terminal 62a and cathode lead terminal 62b extend. Two dummy terminals 8 extend in directions opposite to each other along the same direction. The number of dummy terminals 8 may be one or three or more.

According to this configuration, dummy terminal 8 and auxiliary heat dissipation member 9 function as a transfer path through which the heat generated in capacitor element 3 and conducted to container 2 is transferred from container 2a and heat dissipation member 4 to the substrate. As a result, an effect that the heat generated in container 2a is easily dissipated to the substrate is achieved That is, electrolytic capacitor 100a has an advantage of being able to more efficiently dissipate heat generated inside.

Although auxiliary heat dissipation member 9 illustrated in FIG. 25 is in contact with each of container 2a, heat dissipation member 4, and dummy terminal 8, it may be in contact with each of dummy terminal 8 and at least one of container 2a or beat dissipation member 4. That is, dummy terminal 8 may be in contact with at least one of container 2a or heat dissipation member 4 via auxiliary heat dissipation member 9.

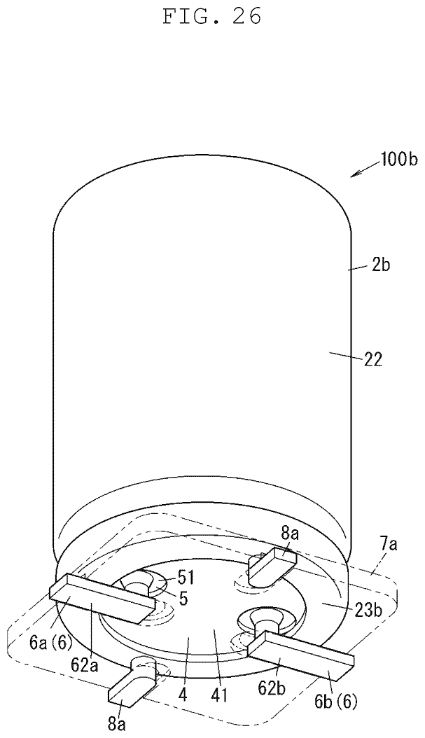

Dummy terminal 8 may be in direct contact with at least one of container 2a or heat dissipation member 4 not via auxiliary heat dissipation member 9. That is, dummy terminal 8 may be in direct or indirect contact with at least one of container 2a or heat dissipation member 4. For example, as illustrated in FIG. 26, dummy terminal 8a may be provided directly on drawing portion 23b of container 2b. In this case, in electrolytic capacitor 100b, heat generated inside container 2b and conducted to container 2b is conducted to the substrate via dummy terminal 8a and dissipated.

Auxiliary heat dissipation member 9 may be in direct contact with at least one of container 2a or heat dissipation member 4 without using dummy terminal 8. That is, auxiliary heat dissipation member 9 may be in direct or indirect contact with at least one of container 2a or heat dissipation member 4.

### (3-4-2) Second Modification

Modifications of the above-described exemplary embodiment will be described below. The following modifications may also be implemented in combinations as appropriate.

The shape of container 2 of the above-described exemplary embodiment is a circular shape in plan view as viewed in the upper direction. For example, container 2 may have an oval shape in plan view as viewed from above. When the shape of container 2 in plan view as viewed from above is an oval shape, the shape of winding portion 31 in plan view as viewed from above may also be an oval shape.

Container 2 may have a shape capable of housing capacitor element 3, heat dissipation member 4, and at least a part of the pair of lead members 6.

Plate portion 41 of the above-described exemplary embodiment covers the entirety of opening 24. However, plate portion 41 may cover at least a part of opening 24.

This configuration has an advantage that capacitor element 3 housed in container 2 can be protected.

The column portion of the above-described exemplary embodiment is a cylinder, but may have a prismatic shape. That is, column portion 42 may have any shape that can be inserted into winding portion 31.

The upper end of column portion 42 of the above-described exemplary embodiment is not in contact with bottom 21 but may be in contact with bottom 21. When the upper end of column portion 42 is in contact with bottom 21, heat generated inside container 2 is dissipated from the upper end of column portion 42 to bottom 21. Therefore, electrolytic capacitor 100 has an advantage of being able to more efficiently dissipate heat generated inside.

Plate portion 41 of the above-described exemplary embodiment is mechanically connected to container 2 by the drawing process. However, plate portion 41 may be fixed with an adhesive. More specifically, plate portion 41 may be fixed to exposed surface 51 of sealer 5 with an adhesive. Plate portion 41 may be fixed to mount surface 72 of base plate 7 with an adhesive.

Plate portion 41 of the above-described exemplary embodiment is sandwiched between exposed surface 51 of sealer 5 and the inner surface of drawing portion 23. Meanwhile, plate portion 41 may be disposed between capacitor element 3 and sealer 5, or may be disposed between bottom 21 of container 2 and capacitor element 3.

Heat dissipation member 4 of the above-described exemplary embodiment is formed of a material having a thermal conductivity of greater than or equal to 155 W/m·K and a Young's modulus of greater than or equal to 1 GPa and less than or equal to 500 GPa. However, heat dissipation member 4 may be made of a material satisfying at least one of a thermal conductivity of greater than or equal to 155 W/m·K or a Young's modulus of greater than or equal to 1 GPa and less than or equal to 500 GPa.

Anode lead terminal 62a of the above-described exemplary embodiment is a plate member or a linear member extending in a direction different from the direction in which anode lead body 61a extends. However, anode lead terminal 62a may be a plate member or a linear member extending in the same direction as the direction in which anode lead body 61a extends. That is, anode lead terminal 62a may be a plate member or a linear member extending in the up-down direction.

Similarly, cathode lead terminal 62b of the above-described exemplary embodiment is a plate member or a linear member extending in a direction different from the direction in which cathode lead body 61b extends. However, cathode lead terminal 62b may be a plate member or a linear member extending in the same direction as the direction in which cathode lead body 61b extends. That is, cathode lead terminal 62b may be a plate member or a linear member extending in the up-down direction.

In this case, electrolytic capacitor 100 is mounted on the substrate by inserting and soldering anode lead terminal 62a and cathode lead terminal 62b to a hole provided in the substrate. In general, the above mounting method is called through-hole mounting or insertion mounting.

### Conclusions

Electrolytic capacitor (1, 1a to 1c, or 10) according to the first aspect of the exemplary embodiment includes winding portion (31), anode lead member (6a), and cathode lead member (6b). Winding portion (31) includes anode foil (311) and cathode foil (312) that are wound. Anode lead member (6a) is connected to anode foil (311) and extends in the first direction. Cathode lead member (6b) is connected to cathode foil (312) and extends in the first direction. Winding portion (31) has a shape viewed in the first direction, the shape including first peripheral region (A1) and second peripheral region (A2) that are opposed to each other in a second direction intersecting the first direction, and third peripheral region (A3) and fourth peripheral region (A4) that are opposed to each other in a third direction intersecting the first direction and the second direction. A length of winding portion (31) in the third direction is larger than a length of winding portion (31) in the second direction. Anode lead member (6a) and cathode lead member (6b) are arranged point-symmetrically with respect to center (P1) of winding portion (31) when viewed in the first direction.

According to this aspect, an insulation distance between anode lead member (6a) and cathode lead member (6b) can be secured. Stability of electrolytic capacitor (1, 1a to 1c, or 10) can be improved.

Electrolytic capacitor (1b) according to the second aspect of the exemplary embodiment includes, in the first aspect, first anode lead member (6a), which is anode lead member (6a), and second anode lead member (60a), which is connected to anode foil (311) and extends in the first direction. Second anode lead member (60a) is arranged to face first anode lead member (6a) in the second direction.

According to this aspect, stability of electrolytic capacitor (1b) can be improved.

Electrolytic capacitor (1c) according to the third aspect of the exemplary embodiment includes, in the first aspect, first cathode lead member (6b), which is cathode lead member (6b), and second cathode lead member (60b), which is connected to cathode foil (312) and extends in the first direction. Second cathode lead member (60b) is arranged to face first cathode lead member (6b) in the second direction.

According to this aspect, stability of electrolytic capacitor (1c) can be improved.

Electrolytic capacitor (10) according to a fourth aspect of the exemplary embodiment includes winding portion (31), first anode lead member (63a) and second anode lead member (600a), and first cathode lead member (63b) and second cathode lead member (600b). Winding portion (31) includes anode foil (311) and cathode foil (312) that are wound. First anode lead member (63a) and second anode lead member (600a) are connected to anode foil (311), and each extend in the first direction. First cathode lead member (63b) and second cathode lead member (600b) are connected to cathode foil (312) and each extend in the first direction. Winding portion (31) has a shape viewed in the first direction, the shape including first peripheral region (A1) and second peripheral region (A2) that are opposed to each other in a second direction intersecting the first direction, and third peripheral region (A3) and fourth peripheral region (A4) that are opposed to each other in a third direction intersecting the first direction and the second direction. A length of winding portion (31) in the third direction is larger than a length of winding portion (31) in the second direction. First anode lead member (63a) is located at first end (ED1) of first peripheral region (A1) when viewed in the first direction. First cathode lead member (63b) is located at second end (ED2) of first peripheral region (A1) when viewed in the first direction. Second anode lead member (600a) is located at third end (ED3) of second peripheral region (A2) when viewed in the first direction, third end (ED3) being opposed to first end (ED1). Second cathode lead member (600b) is located at fourth end (ED4) of second peripheral region (A2) when viewed in the first direction, fourth end (ED4) being opposed to second end (ED2).

According to this aspect, an insulation distance between first anode lead member (63a) and second anode lead member (600a) and first cathode lead member (63b) and second cathode lead member (600b) can be secured. Stability of electrolytic capacitor (10) can be improved.

Electrolytic capacitor (1, 1a to 1c, or 10) according to a fifth aspect of the exemplary embodiment further includes, in any of the first to fourth aspects, container (2), which houses winding portion (31), and heat dissipation member (4), which dissipates heat generated inside container (2). Heat dissipation member (4) includes plate portion (41) having a plate shape and column portion (42) extending from one surface (412) of plate portion (41). Column portion (42) is inserted into winding portion (31). Plate portion (41) is in contact with container (2).

According to this aspect, heat generated inside container (2) can be efficiently dissipated.

In electrolytic capacitor (1, 1a to 1c, or 10) according to a sixth aspect of the exemplary embodiment, in the fifth aspect, column portion (42) has a plate shape.

According to this aspect, heat generated inside container (2) can be efficiently dissipated.

In electrolytic capacitor (1, 1a to 1c, or 10) according to a seventh aspect of the exemplary embodiment, in the fifth or sixth aspect, heat dissipation member (4) is formed of a material having a thermal conductivity of greater than or equal to 155 W/m·K.

According to this aspect, heat generated inside container (2) can be efficiently dissipated.

In electrolytic capacitor (1, 1a to 1c, or 10) according to an eighth aspect of the exemplary embodiment, in the fifth to seventh aspects, container (2) includes opening (24). Plate portion (41) covers at least a part of opening (24).

According to this aspect, deformation of sealer (5) can be suppressed when pressure inside of electrolytic capacitor (1, 1a to 1c, or 10) increases, and therefore stress applied to capacitor element (3) housed in container (2) can be relaxed, and capacitor element (3) can be protected.

In electrolytic capacitor (1, 1a to 1c, or 10) according to a ninth aspect of the exemplary embodiment, in the eighth aspect, plate portion (41) is in contact with container (2) by subjecting a drawing to a part of the container (2).

According to this aspect, heat generated inside container (2) can be efficiently dissipated from container (2).

Electrolytic capacitor (1, 1a to 1c, or 10) according to a 10th aspect of the exemplary embodiment further includes, in the eighth or ninth aspect, sealer (5) that seals opening (24). Sealer (5) has exposed surface (51) exposed from opening (24). Heat dissipation member (4) is disposed in contact with exposed surface (51).

According to this aspect, the strength of sealer (5) can be reinforced by heat dissipation member (4).

In electrolytic capacitor (1, 1a to 1c, or 10) according to an 11th aspect of the exemplary embodiment, in the 10th aspect, heat dissipation member (4) is formed of a material higher in Young's modulus than a Young's modulus of sealer (5).

According to this aspect, deformation of sealer (5) in container (2) can be suppressed.

In electrolytic capacitor (1, 1a to 1c, or 10) according to a 12th aspect of the exemplary embodiment, in the 11th aspect, heat dissipation member (4) is formed of a material having the Young's modulus of greater than or equal to 1 GPa and less than or equal to 500 GPa.

According to this aspect, deformation of sealer (5) in container (2) can be suppressed.

Electrolytic capacitor (1, 1a to 1c, or 10) according to a 13th aspect of the exemplary embodiment further includes, in any of the fifth to 12th aspects, dummy terminal (8) fixed to a substrate mounted with container (2). Dummy terminal (8) is in direct or indirect contact with at least one of container (2) or heat dissipation member (4).

According to this aspect, heat generated inside container (2) can be efficiently dissipated to the substrate via dummy terminal (8).

Electrolytic capacitor (1, 1a to 1c, or 10) according to a 14th aspect of the exemplary embodiment further includes, in the 13th aspect, auxiliary heat dissipation member (9). Auxiliary heat dissipation member (9) is in contact with each of dummy terminal (8) and at least one of container (2) or heat dissipation member (4). Dummy terminal (8) is in contact with at least one of container (2) or heat dissipation member (4) via auxiliary heat dissipation member (9).

According to this aspect, heat generated inside container (2) can be efficiently dissipated to the substrate via dummy terminal (8) and auxiliary heat dissipation member (9).

Electrolytic capacitor (100, 100a, or 100b) of a 15th aspect according to the exemplary embodiment includes capacitor element (3), container (2, 2a, or 2b), and heat dissipation member (4). Capacitor element (3) includes winding portion (31) in which an anode foil and a cathode foil are wound. Container (2, 2a, or 2b) houses capacitor element (3). Heat dissipation member (4) dissipates heat generated inside container (2, 2a, or 2b). Heat dissipation member (4) includes plate portion (41) having a plate shape and column portion (42) extending from one surface of plate portion (41). Column portion (42) is inserted into winding portion (31). Plate portion (41) is in contact with container (2, 2a, or 2b).

According to this aspect, there is an advantage that heat generated inside can be efficiently dissipated.

In electrolytic capacitor (100, 100a, or 100b) of a 16th aspect according to the exemplary embodiment, in the first aspect, column portion (42) has a cylindrical shape.

According to this aspect, there is an advantage that heat generated inside can be dissipated more efficiently. There is also an advantage that breakage of lead member (6) can be suppressed.

In electrolytic capacitor (100, 100a, or 100b) of a 17th aspect according to the exemplary embodiment, in the first or second aspect, heat dissipation member (4) is formed of a material having a thermal conductivity of greater than or equal to 155 W/m·K.

According to this aspect, there is an advantage that heat generated inside can be dissipated more efficiently.

In electrolytic capacitor (100, 100a, or 100b) of an 18th aspect according to the exemplary embodiment, in any of the first to third aspects, container (2, 2a, or 2b) includes opening (24). Plate portion (41) covers at least a part of opening (24).

According to this aspect, there is an advantage that capacitor element (3) housed in container (2, 2a, or 2b) can be protected.

In an electrolytic capacitor (100, 100a, or 100b) of a 19th aspect according to the exemplary embodiment, in the fourth aspect, plate portion (41) is in contact with container (2, 2a, or 2b) by a drawing.

According to this aspect, there is an advantage that heat generated inside can be reliably dissipated to container (2, 2a, or 2b).

Electrolytic capacitor (100, 100a, or 100b) of a 20th aspect according to the exemplary embodiment further includes, in the fourth or fifth aspect, sealer (5) that seals opening (24). Sealer (5) has exposed surface (51) exposed from opening (24). Heat dissipation member (4) is disposed in contact with exposed surface (51).

According to this aspect, there is an advantage that capacitor element (3) to be housed in container (2, 2a, or 2b) can be enlarged, and the charge amount stored in electrolytic capacitor (100, 100a, or 100b) can be increased.

In electrolytic capacitor (100, 100a, or 100b) of a 21st aspect according to the exemplary embodiment, in the sixth aspect, heat dissipation member (4) is formed of a material higher in Young's modulus than a Young's modulus of sealer (5).

According to this aspect, there is an advantage that deformation of sealer (5) due to an increase in the internal pressure of container (2, 2a, or 2b) can be suppressed.

In electrolytic capacitor (100, 100a, or 100b) of a 22nd aspect according to the exemplary embodiment, in the seventh aspect, heat dissipation member (4) is formed of a material having a Young's modulus of greater than or equal to 1 GPa and less than or equal to 500 GPa.

According to this aspect, there is an advantage that vibration in a radial direction of capacitor element (3) can be suppressed.

Electrolytic capacitor (100a or 100b) of a 23rd aspect according to the exemplary embodiment further includes, in any of the first to eighth aspects, dummy terminal (8 or 8a) fixed to a substrate mounted with container (2a or 2b). Dummy terminal (8 or 8a) is in direct or indirect contact with at least one of container (2a or 2b) or heat dissipation member (4).

According to this aspect, there is an advantage that capacitor element (3) housed in container (2) can be protected.

Electrolytic capacitor (100a) of a 24th aspect according to the exemplary embodiment further includes, in the ninth aspect, auxiliary heat dissipation member (9) in contact with each of dummy terminal (8) and at least one of container (2a) or heat dissipation member (4). Dummy terminal (8) is in contact with at least one of container (2a) or heat dissipation member (4) via auxiliary heat dissipation member (9).

According to this aspect, there is an advantage that heat generated inside can be dissipated more efficiently.

### REFERENCE MARKS IN THE DRAWINGS

1, 1a to 1c: electrolytic capacitor
10: electrolytic capacitor
100, 100a, 100b: electrolytic capacitor
2, 2a, 2b: container
3: capacitor element
4: heat dissipation member
5: sealer
8, 8a: dummy terminal
9: auxiliary heat dissipation member
24, 24a, 24b: opening
31: winding portion
41: plate portion
42: column portion
51: exposed surface
52, 53a, 53b: through-hole
311: anode foil
312: cathode foil
412: one surface
600a: second anode lead member
600b: second cathode lead member
60a: second anode lead member
63a: first anode lead member
60b: second cathode lead member
63b: first cathode lead member
6a: anode lead member
6b: cathode lead member
A1: first peripheral region
A2: second peripheral region
A3: third peripheral region
A4: fourth peripheral region
ED1: first end
ED2: second end
ED3: third end
ED4: fourth end
P1: center

1. An electrolytic capacitor comprising:
a winding portion including an anode foil and cathode foil that are wound;
an anode lead member connected to the anode foil and extending in a first direction; and
a cathode lead member connected to the cathode foil and extending in the first direction, wherein:
the winding portion has a shape viewed in the first direction, the shape including a first peripheral region and a second peripheral region that are opposed to each other in a second direction intersecting the first direction, and a third peripheral region and a fourth peripheral region that are opposed to each other in a third direction intersecting the first direction and the second direction,
a length of the winding portion in the third direction is larger than a length of the winding portion in the second direction, and
the anode lead member and the cathode lead member are arranged point-symmetrically with respect to a center of the winding portion when viewed in the first direction.

2. The electrolytic capacitor according to claim 1 comprising:
a first anode lead member that is the anode lead member; and
a second anode lead member connected to the anode foil and extending in the first direction, wherein the second anode lead member is arranged to face the first anode lead member in the second direction.

3. The electrolytic capacitor according to claim 1 comprising:
a first cathode lead member that is the cathode lead member; and
a second cathode lead member connected to the cathode foil and extending in the first direction, wherein the second cathode lead member is arranged to face the first cathode lead member in the second direction.

4. An electrolytic capacitor comprising:
a winding portion including an anode foil and cathode foil that are wound;
a first anode lead member and a second anode lead member that are connected to the anode foil and each extend in a first direction; and
a first cathode lead member and a second cathode lead member that are connected to the cathode foil and each extend in the first direction, wherein:
the winding portion has a shape viewed in the first direction, the shape including a first peripheral region and a second peripheral region that are opposed to each other in a second direction intersecting the first direction, and a third peripheral region and a fourth peripheral region that are opposed to each other in a third direction intersecting the first direction and the second direction,
a length of the winding portion in the third direction is larger than a length of the winding portion in the second direction,
the first peripheral region includes a first end and a second end that are opposed to each other in the third direction,
the second peripheral region includes a third end and a fourth end that are opposed to each other in the third direction,
the first end of the first peripheral region and the third end of the second peripheral region are opposed to each other in the second direction,
the second end of the first peripheral region and the fourth end of the second peripheral region are opposed to each other in the second direction,
the first anode lead member is located at the first end of the first peripheral region when viewed in the first direction,
the first cathode lead member is located at the second end of the first peripheral region when viewed in the first direction,
the second anode lead member is located at the third end of the second peripheral region when viewed in the first direction, and
the second cathode lead member is located at the fourth end of the second peripheral region when viewed in the first direction.

5. The electrolytic capacitor according to claim 1 further comprising:
a container that houses the winding portion; and
a heat dissipation member that dissipates heat generated inside the container, wherein:
the heat dissipation member includes a plate portion having a plate shape and a column portion extending from one surface of the plate portion,
the column portion is inserted into the winding portion, and
the plate portion is in contact with the container.

6. The electrolytic capacitor according to claim 5, wherein the column portion has a plate shape.

7. The electrolytic capacitor according to claim 5, wherein the heat dissipation member is formed of a material having a thermal conductivity of greater than or equal to 155 W/m·K.

8. The electrolytic capacitor according to claim 5, wherein:
the container has an opening, and
the plate portion covers at least a part of the opening.

9. The electrolytic capacitor according to claim 8, wherein the plate portion is in contact with the container by subjecting a drawing to a part of the container.

10. The electrolytic capacitor according to claim 8 further comprising a sealer that seals the opening, wherein:
the sealer has an exposed surface exposed from the opening, and
the heat dissipation member is disposed in contact with the exposed surface.

11. The electrolytic capacitor according to claim 10, wherein the heat dissipation member is formed of a material having a Young's modulus higher than a Young's modulus of the sealer.

12. The electrolytic capacitor according to claim 11, wherein the heat dissipation member is formed of a material having the Young's modulus of greater than or equal to 1 GPa and less than or equal to 500 GPa.

13. The electrolytic capacitor according to claim 5 further comprising a dummy terminal fixed to a substrate mounted with the container, wherein the dummy terminal is in direct or indirect contact with at least one of the container or the heat dissipation member.

14. The electrolytic capacitor according to claim 13 further comprising an auxiliary heat dissipation member in contact with at least one of the container or the heat dissipation member and in contact with the dummy terminal, wherein the dummy terminal is in contact with at least one of the container or the heat dissipation member via the auxiliary heat dissipation member.

15. An electrolytic capacitor comprising:
a capacitor element including a winding portion in which an anode foil and a cathode foil are wound;
a container that houses the capacitor element; and
a heat dissipation member that dissipates heat generated inside the container, wherein:
the heat dissipation member includes a plate portion having a plate shape and a column portion extending from one surface of the plate portion,
the column portion is inserted into the winding portion, and
the plate portion is in contact with the container.

16. The electrolytic capacitor according to claim 15, wherein the column portion has a cylindrical shape.

17. The electrolytic capacitor according to claim 15, wherein the heat dissipation member is formed of a material having a thermal conductivity of greater than or equal to 155 W/m·K.

18. The electrolytic capacitor according to claim 15, wherein:
the container includes an opening, and
the plate portion covers at least a part of the opening.

19. The electrolytic capacitor according to claim 18, wherein the plate portion is in contact with the container by a drawing.

20. The electrolytic capacitor according to claim 18 further comprising a sealer that seals the opening, wherein:
the sealer has an exposed surface exposed from the opening, and
the heat dissipation member is disposed in contact with the exposed surface.

21. The electrolytic capacitor according to claim 20, wherein the heat dissipation member is formed of a material having a Young's modulus higher than a Young's modulus of the sealer.

22. The electrolytic capacitor according to claim 21, wherein the heat dissipation member is formed of a material having the Young's modulus of greater than or equal to 1 GPa and less than or equal to 500 GPa.

23. The electrolytic capacitor according to claim 15 further comprising a dummy terminal fixed to a substrate mounted with the container, wherein the dummy terminal is in direct or indirect contact with at least one of the container or the heat dissipation member.

24. The electrolytic capacitor according to claim 23 further comprising an auxiliary heat dissipation member in contact with at least one of the container or the heat dissipation member and in contact with the dummy terminal, wherein the dummy terminal is in contact with at least one of the container or the heat dissipation member via the auxiliary heat dissipation member.

25. The electrolytic capacitor according to claim 4 further comprising:
a container that houses the winding portion; and
a heat dissipation member that dissipates heat generated inside the container, wherein:
the heat dissipation member includes a plate portion having a plate shape and a column portion extending from one surface of the plate portion,
the column portion is inserted into the winding portion, and
the plate portion is in contact with the container.

26. The electrolytic capacitor according to claim 25, wherein the column portion has a plate shape.

27. The electrolytic capacitor according to claim 25, wherein the heat dissipation member is formed of a material having a thermal conductivity of greater than or equal to 155 W/m·K.

28. The electrolytic capacitor according to claim 25, wherein:
the container has an opening, and
the plate portion covers at least a part of the opening.

29. The electrolytic capacitor according to claim 28, wherein the plate portion is in contact with the container by subjecting a drawing to a part of the container.

30. The electrolytic capacitor according to claim 28 further comprising a sealer that seals the opening, wherein:
the sealer has an exposed surface exposed from the opening, and
the heat dissipation member is disposed in contact with the exposed surface.

31. The electrolytic capacitor according to claim 30, wherein the heat dissipation member is formed of a material having a Young's modulus higher than a Young's modulus of the sealer.

32. The electrolytic capacitor according to claim 31, wherein the heat dissipation member is formed of a material having the Young's modulus of greater than or equal to 1 GPa and less than or equal to 500 GPa.

33. The electrolytic capacitor according to claim 25 further comprising a dummy terminal fixed to a substrate mounted with the container, wherein the dummy terminal is in direct or indirect contact with at least one of the container or the heat dissipation member.

34. The electrolytic capacitor according to claim 33 further comprising an auxiliary heat dissipation member in contact with at least one of the container or the heat dissipation member and in contact with the dummy terminal, wherein the dummy terminal is in contact with at least one of the container or the heat dissipation member via the auxiliary heat dissipation member.
